(19) United States
(12) Patent Application Publication
(10) Pub. No.: US 2007/0156804 A1
(43) Pub. Date: Jul. 5, 2007

(54) System and method for a virtual mobile network supporting dynamic personal virtual mobile network with multimedia service orchestration

(75) Inventor: Richard Mo, Colorado Springs, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Fuze Networks

(21) Appl. No.: 11/650,185

(22) Filed: Jan. 5, 2007

Related U.S. Application Data
(60) Provisional application No. 60/756,285, filed on Jan. 5, 2006.

(51) Int. Cl. G06F 15/16

(52) U.S. Cl. 709/200

(57) ABSTRACT

A system, various methods, and various apparatuses are provided whereby a Dynamic Personal Virtual Mobile Network can be created, in which multiple disparate networks can be interconnected to form a unified network environment. In this Dynamic Personal Virtual Mobile Network topology changes in real time as a user roams. Handover boundaries are established and taken down as the Dynamic Personal Virtual Mobile Network Topology changes. A Dynamic Personal Virtual Mobile Network is constructed with separate signalling and bearer channel infrastructures to afford greater degree of network engineering and provisioning efficiency. In this Dynamic Personal Virtual Mobile Network, dedicated signalling resources are connected always while shared bearer resources are allocated on demand. An architecture, various methods, are also provided whereby multimedia service channels can be organized, adapted, and managed systematically between separate multiple service providers and a user with multiple mobile devices in the context of the Dynamic Personal Virtual Mobile Network.

### RELATED APPLICATIONS

The present invention claims priority on provisional patent application, Ser. No. 60/756,285 filed on Jan. 5, 2006, entitled “System and method for a virtual mobile network supporting dynamic personal virtual mobile network with multimedia service orchestration” and is hereby incorporated by reference.

### TECHNICAL FIELD OF THE INVENTION

This invention pertains in general to electronic communication in circuit switched networks such as those using Time Divisional Multiplex (TDM) voice technologies, and in packet multimedia networks, such as those using Voice over Internet Protocol (VOIP) technologies. The invention pertains in particular to providing a mechanism whereby a Dynamic Personal Virtual Mobile Network can be created, in which multiple disparate and heterogeneous networks can be interconnected to form a unified network environment for an individual user within the context of an overall Virtual Mobile Network. The overall Virtual Mobile Network has been disclosed in a prior Provisional Patent Application US60/664,337 by the present inventor. In this Dynamic Personal Virtual Mobile Network environment a user can extend the mobility coverage area dynamically without complicated network engineering and provisioning. The invention further pertains in particular to a mechanism whereby a Virtual Mobile Network can be constructed with separate signalling and bearer channel infrastructures to afford greater degree of network engineering and provisioning efficiency. In this Virtual Mobile Network, dedicated signalling resources are connected always while shared bearer resources are allocated on demand. The invention further pertains in particular to a mechanism whereby multimedia service channels can be organized, adapted, and managed systematically between separate multiple service providers and a user with multiple mobile devices in the context of the Virtual Mobile Network.

### BACKGROUND OF THE INVENTION

Telecommunication networks are generally designed, engineered and deployed with predefined capacity and coverage to support users within them. Interconnections with other networks are predefined and provisioned. Agreements to interconnect networks usually take long period of time and changes happen slowly. It took a long time to develop roaming agreements between cellular operators to interconnect cellular networks to allow users from one cellular network to roam into another cellular network to get services. Even when available, these connections are done between cellular networks deploying similar technologies and standards. For example, a GSM cellular network usually has roaming agreements with other GSM cellular networks but rarely with other CDMA cellular networks. The interconnection between private mobile networks using WiFi radio technology and public cellular networks are typically not available. Furthermore, as more mobile networks are being deployed with different technologies and standards, such as municipal networks using WiMax technology, interconnections between these isolated mobility environments are becoming ever more complex. At the same time, as the world becomes more mobile, people travel frequently and their Spheres Of Mobility change often, they will encounter unconnected mobile network boundaries more and more.

What is needed, then, is a system which tracks where the user roams and creates a Personal Virtual Mobile Network to co-inside with the user's Sphere Of Mobility automatically. Within this Personal Virtual Mobile Network, users can roam freely and gain access to familiar features and services without experiencing any access network boundary limitations. The Personal Virtual Mobile Network changes dynamically as the user roams without predefined interconnect agreements between the underlying networks. The Personal Virtual Mobile Network will recognize individual user's Sphere Of Mobility Boundaries and provide seamless roaming and handover across the underlying networks. The underlying networks can be either fixed or mobile networks The concept of separating signalling channel from bearer channel has been deployed successfully in the telecom industry for a long time to get faster and more efficient control of the public network resources. The Signalling System 7 (SS7) network was deployed to allow public telephone networks to communicate with each other to perform many time sensitive tasks almost instantaneously. For example, to find out whether a telephone end point is free to take a call, to get a free call number translation, to route around a network node that is in trouble, just to name a few. However, such signalling network is only available to public telephone networks. As a result signalling between private network components across public networks is difficult and usually involves complex protocol conversions and mediation.

As mobile users roam across multiple heterogeneous access networks with sophisticated and media-rich devices the need to signal across these networks with the application servers become critical. For example, an enterprise mobile user may engage in a multimedia communication session which involves a telephone conversation through a voice switch server behind an enterprise firewall; a TV News session through a news video streaming server connected via the Internet; and receiving real time stock ticker notice through a public stock brokerage service server. To support such a multimedia service a service provider must either build a network which is capable of supporting voice, data and high speed video communication or assemble a suit of needed communication channels from a number of networks specialized for each the services. While having a single multimedia network covering everywhere the user roam will no doubt create the best service performance, building such network is both expensive and time consuming, resulting in long service availability delay and slow service enhancements implementation.

What is needed, then, is a system which facilitates the assembly of any needed communication channels from the best access network available to support the multimedia services desired by the user. Such system will enable fast and efficient signalling between the mobile multimedia devices and the application servers providing either a single medium service or multimedia services across the access networks.

As mobile devices get more capable and the mobile applications become more sophisticated, mixed media communication are becoming the norm. Users found themselves establishing one connection to one service at a time from these multimedia devices. Since each of the connections is made in isolation, co-ordinations between these services and connections are left to the user. For example, a user may use a GSM cellular and WiFi dual mode device with one connection to the GSM network for cellular voice service, a GPRS data connection for stock ticker update service, and a broad band connection via the WiFi access to the CNN news streaming service. When the user moves away from the WiFi coverage, the CNN news service may be disrupted and the user may have to re-establish the connection with the slower GPRS connection. When the user roam back into the higher bandwidth WiFi area, he may have to re-establish the WiFi connection to get better video streaming performance, assuming he is aware of the availability of the better performance WiFi connection. This is very cumbersome and performance is sporadic at best.

What is needed, then, is a system which sits between the mobile multimedia devices and the application service providers, to co-ordinate and manage the various disparate service channels systematically for the user. When the user moves across boundaries of access networks, the system would organize the appropriate channels, handover the channels from one network to the other, and adapt the service appropriate for the new access channel capability.

### SUMMARY OF THE INVENTION

Accordingly, it is an advantage of the present invention that a simple, universal means is provided to interconnect disparate access networks, regardless whether the networks are public switch networks, public cellular networks or private enterprise networks, whether the networks are circuit switched networks, IP-based networks, radio networks or wired networks to form a Dynamic Personal Virtual Mobile Network. In that the topology of this Dynamic Personal Virtual Mobile Network changes automatically as the user roams across these disparate networks. A user can access services such as teleservice and multimedia services, well known to the skilled in the arts, anywhere within this Personal Virtual Mobile Network.

It is a further advantage of the present invention that a single always connected signalling channel with multiple on demand bearer channels can be established between a multimedia mobile device over multiple heterogeneous networks. This arrangement enables the multimedia device to be connected to the network with the minimal bandwidth for signalling and management purposes while appropriate or best available band width bearer channels can be added or removed as needed over available access networks. The Multimedia device can communicate, co-ordinate and manage all the bearer channels via the single signalling channel.

Further more, it is also the advantage of the present invention that a systematic means is provided to co-ordinate and orchestrate multiple multimedia connections between multiple service providers and a multimedia mobile device. In that as the user roams across network boundaries the system co-ordinates with the mobile device to handover multiple connections as required automatically. It adapts the service in accordance to the available channel capabilities and maintains the best possible Quality Of Service.

It is a principal aim of the present invention to create a set of systems and methods with which a Personal Virtual Mobile Network can be created, in which multiple disparate networks can be interconnected to form a unified personal mobile network environment for the individual user. In this Personal Virtual Mobile Network environment a user may roam and handover an active call seamlessly, without user perceptible delays, between any two networks or subnets interconnected via the Public Switched Telephone Network, the Internet, or any IP network. For example, between: a) two private networks; b) a private network and a public cellular network; c) a private network and a public carrier network; and d) between two radio subnets of a private network. This Personal Virtual Mobile Network will change dynamically as the user roams to new areas and networks without predefined interconnect agreements between the underlying networks.

It is thus another principal aim of the present invention to provide a system that creates a single virtual signalling channel between the multimedia device and the application servers enabling fast and efficient signalling between the application servers and the mobile device across multiple access networks and multiple core application networks. The system facilitates adding and removing communication bearer channels as needed by the services. These bearer channels may be assembled form a single network infrastructure or from multiple heterogeneous networks.

It is thus another principal aim of the present invention to provide a system that coordinates and manages multiple media channels for the user automatically. These multiple media services may originate from different application networks and the mobile device may employ multiple access channels to connect to these services. The system selects the best access network available to connect the device to the desire services automatically. As the user roams, the system selects the best available access channels to handover the connections transparently to maintain a stable and best performance possible communication experience for the user.

The above and other advantages of the present invention are carried out in one form by a system of cooperating elements, each of which applies algorithms and other procedural means as specified below to ensure the interconnected networks function as a unified and seamless Personal Virtual Mobile Network to service the user.

### BRIEF DESCRIPTION OF THE DRAWINGS

The invention will be better understood from a reading of the following detailed description in conjunction with the drawing figures, in which like reference designators are used to identify like elements and in which:

FIG. 1 illustrates a high-level block diagram of the overall system in which the Virtual Mobile Network capability of the present invention operates;

FIG. 2 illustrates a block diagram of a software program and corresponding computer system which can operate as a Mobile Station in the system of the present invention;

FIG. 3 illustrates a block diagram of a software program and corresponding computer system which can operate as a Mobility Orchestration Server in the system of the present invention;

FIG. 3a is a block diagram of the Mobility Orchestration Server in an enterprise application of the present invention;

FIG. 4 illustrates a protocol architecture with which a Virtual Mobile Network can be implemented across various network elements in accordance with the present invention.

FIG. 5 illustrates a high level block diagram of an implementation of a Virtual Mobile Network extending the voice service from an Enterprise core network through a Cellular access network to a mobile user in accordance with the present invention;

FIG. 6 illustrates different Personal Virtual Mobile Networks overlay on an Enterprise Virtual Mobile Network in accordance with the present invention;

FIG. 7 illustrates how a Multimedia Orchestration Architecture facilitates the separate management of the connections to multiple multimedia service providers, the connections to multimedia mobile devices and the adaptation between the two types of connections in accordance with an embodiment of the present invention;

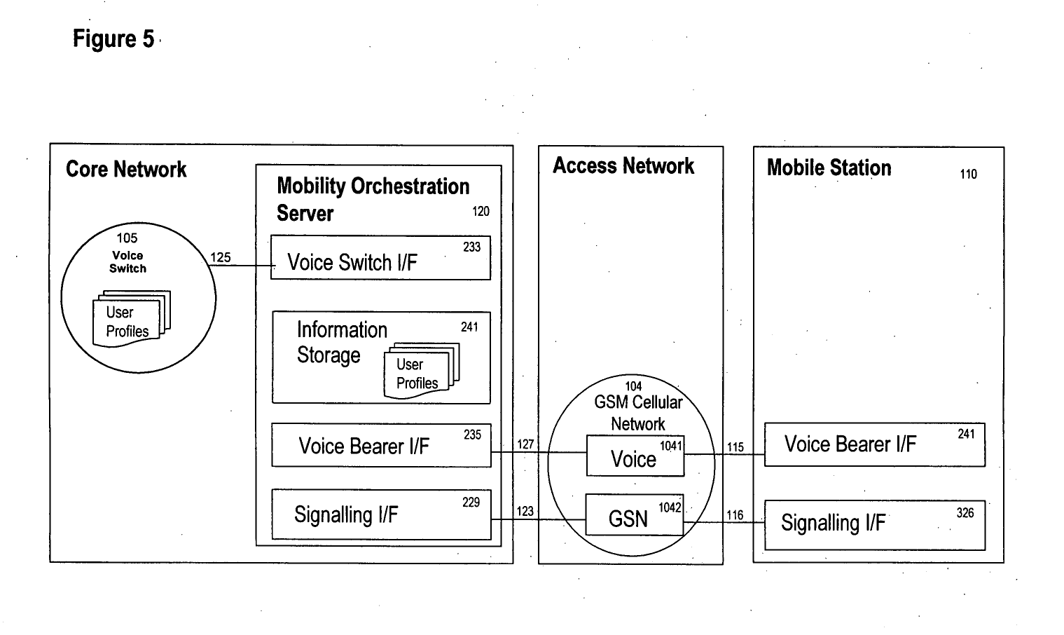

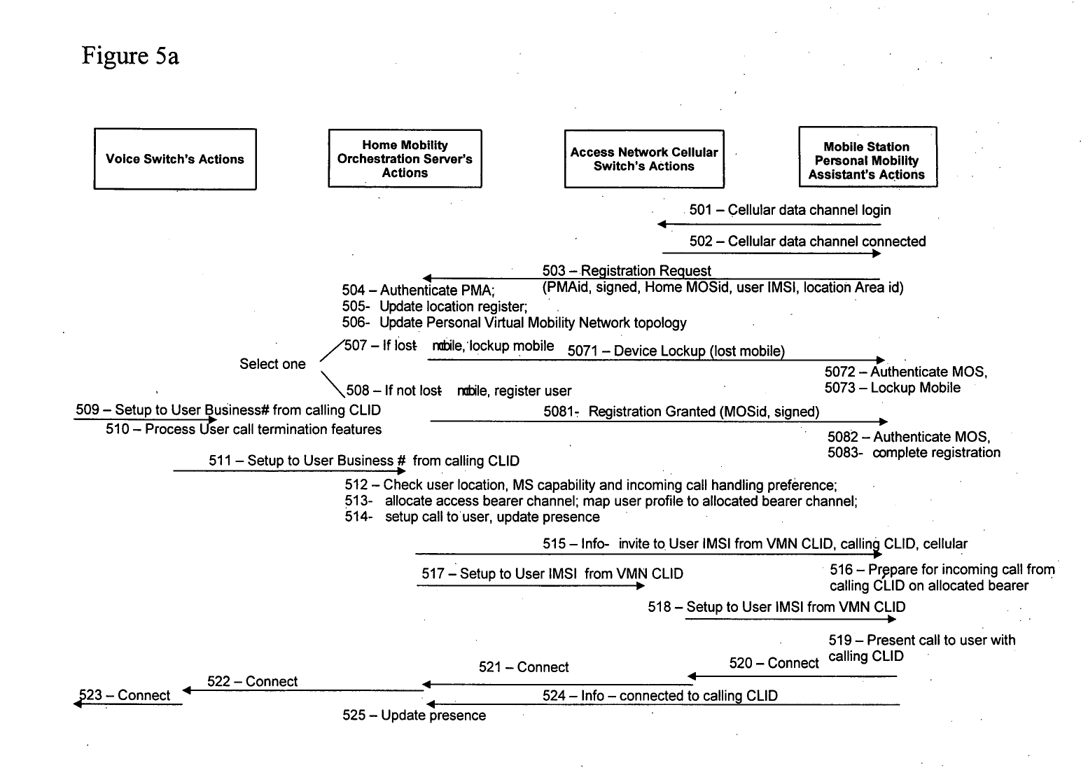

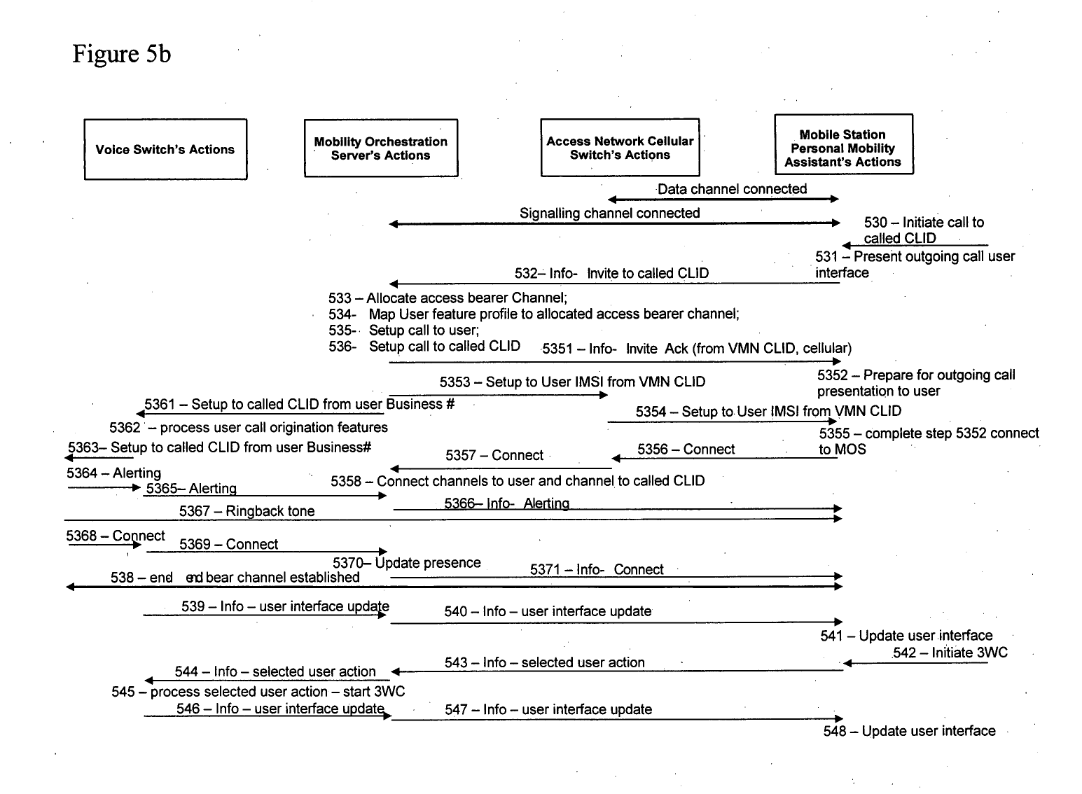

FIG. 5a illustrates a combination signalling sequence chart and flow chart for establishing a signalling channel and allocating a bearer channel to handle an incoming call to a user in accordance with an embodiment of the present invention in which a Cellular Network is being used as the access network;

FIG. 5b illustrates a combination signalling sequence chart and flow chart for capturing an outgoing call attempt from the mobile device and service the outgoing call request with an embodiment of the present invention in which a Cellular Network is being used as the access network and an Enterprise Voice Switch is used to service the outgoing call;

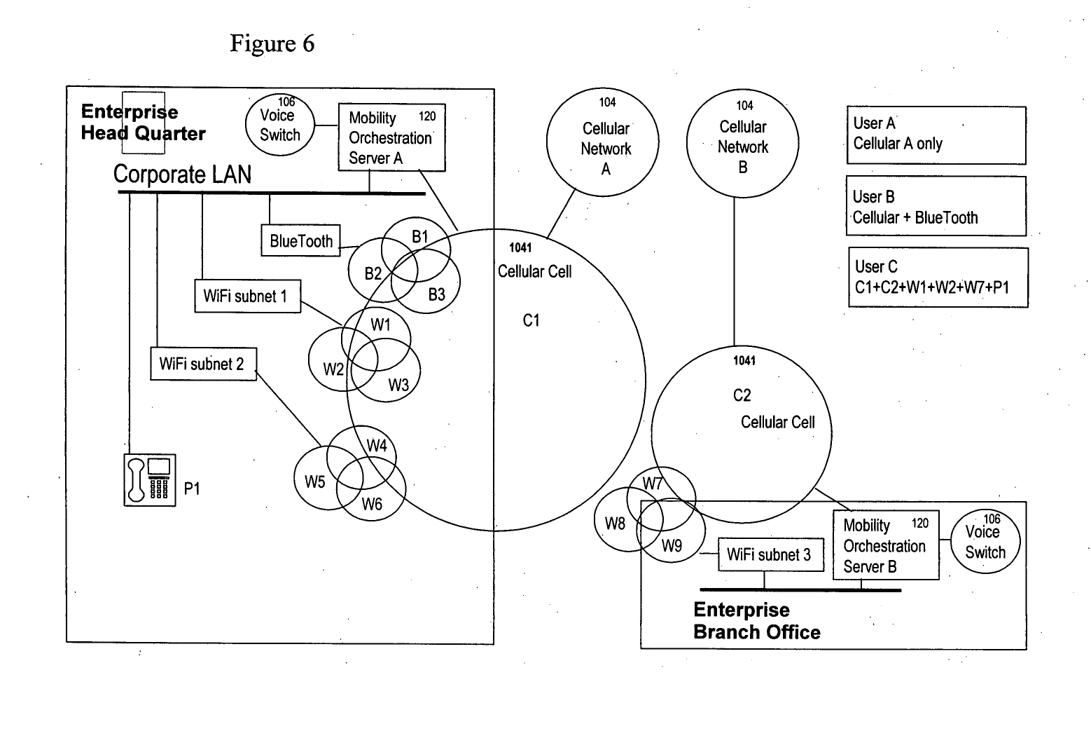

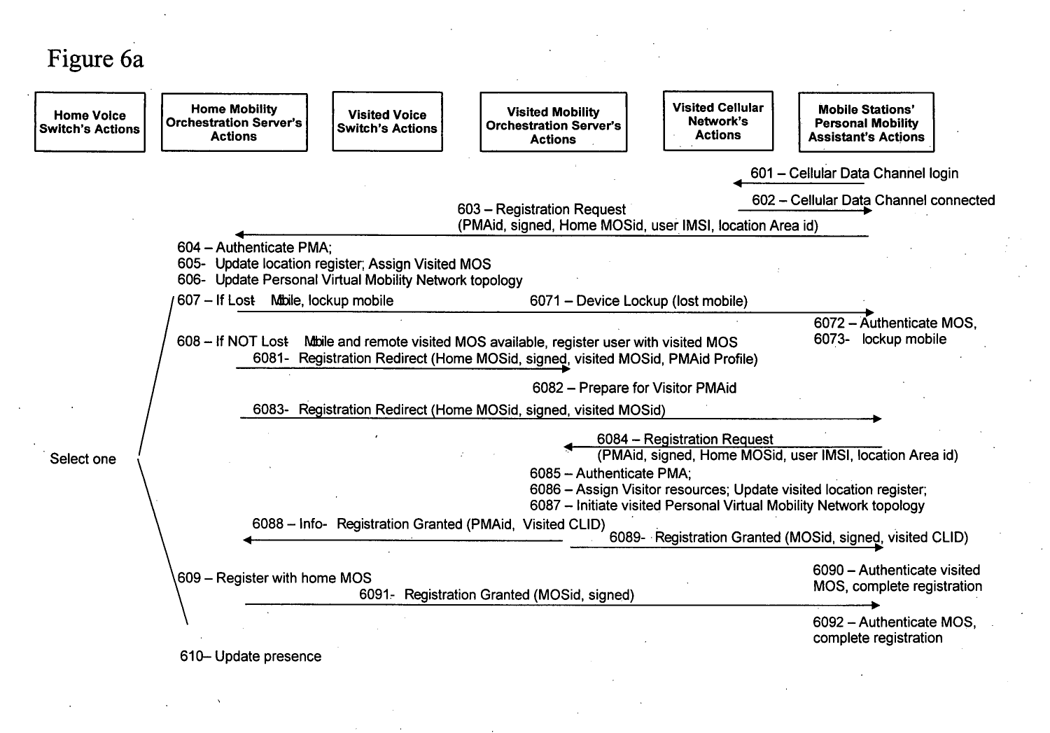

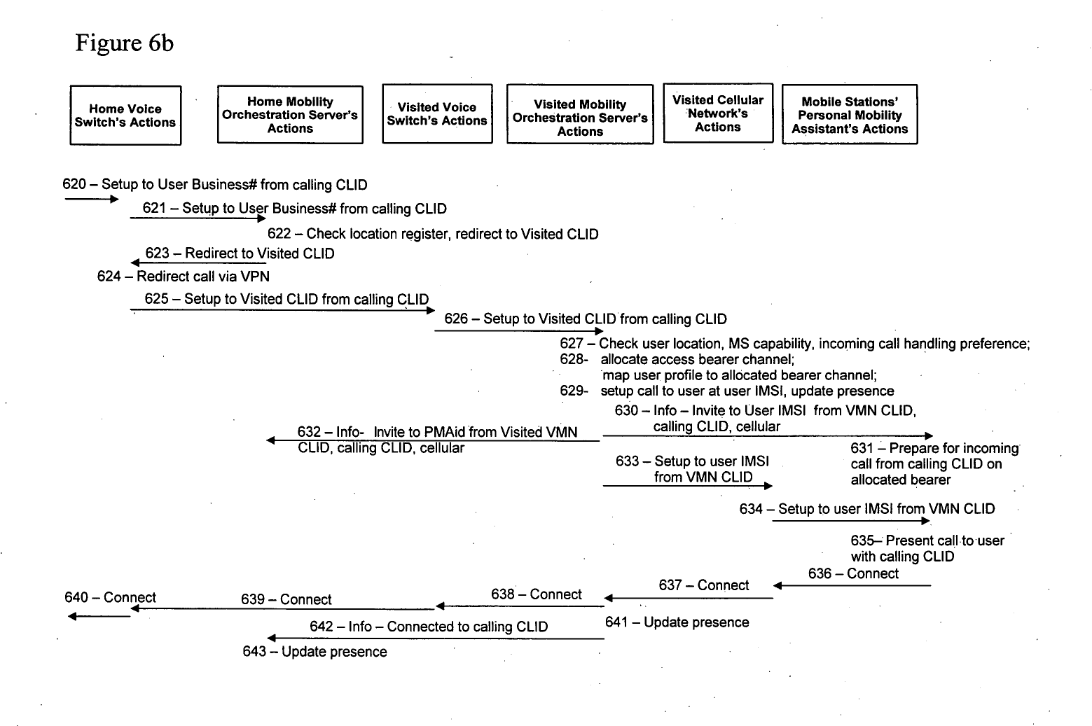

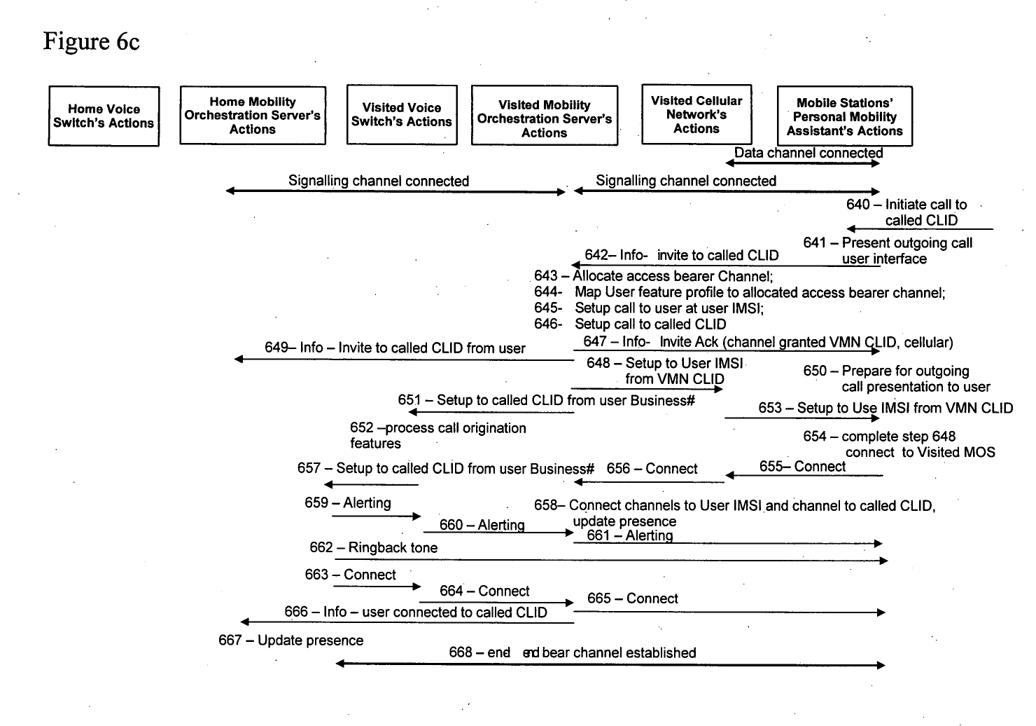

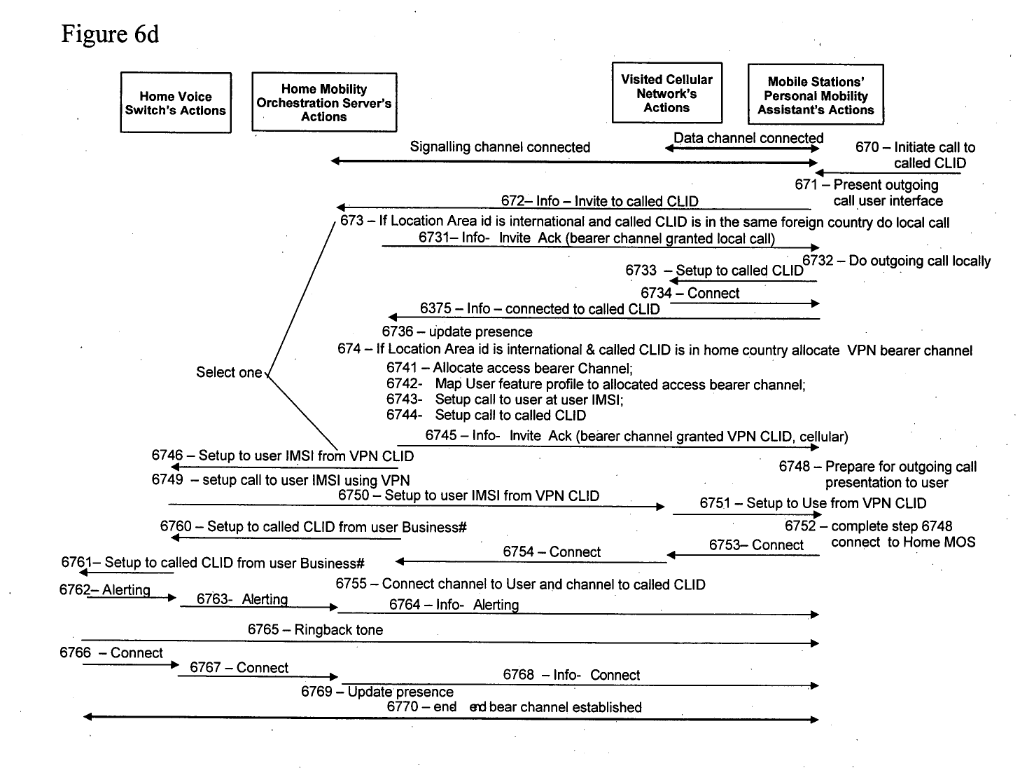

FIG. 6a illustrate a combination signalling sequence chart and flow chart for a user registering via a foreign cellular network served by a remote Mobility Orchestration Server in accordance with the present invention;

FIG. 6b illustrate a combination signalling sequence chart and flow chart on how an incoming call is routed via the Enterprise VPN to a user registered from a foreign Cellular Network in accordance with the present invention;

FIG. 6c illustrates a combination signalling sequence chart and flow chart for capturing an outgoing call attempt from a remote registered mobile device and service the outgoing call request by a remote Mobility Orchestration Server with an embodiment of the present invention in which a Remote Cellular Network is being used as the access network and a Remote Voice Switch is used to service the outgoing call;

FIG. 6d illustrates a combination signalling sequence chart and flow chart for capturing an outgoing call attempt from a remote registered mobile device and service the outgoing call request by a local Mobility Orchestration Server with an embodiment of the present invention in which a Remote Cellular Network is being used as the access network;

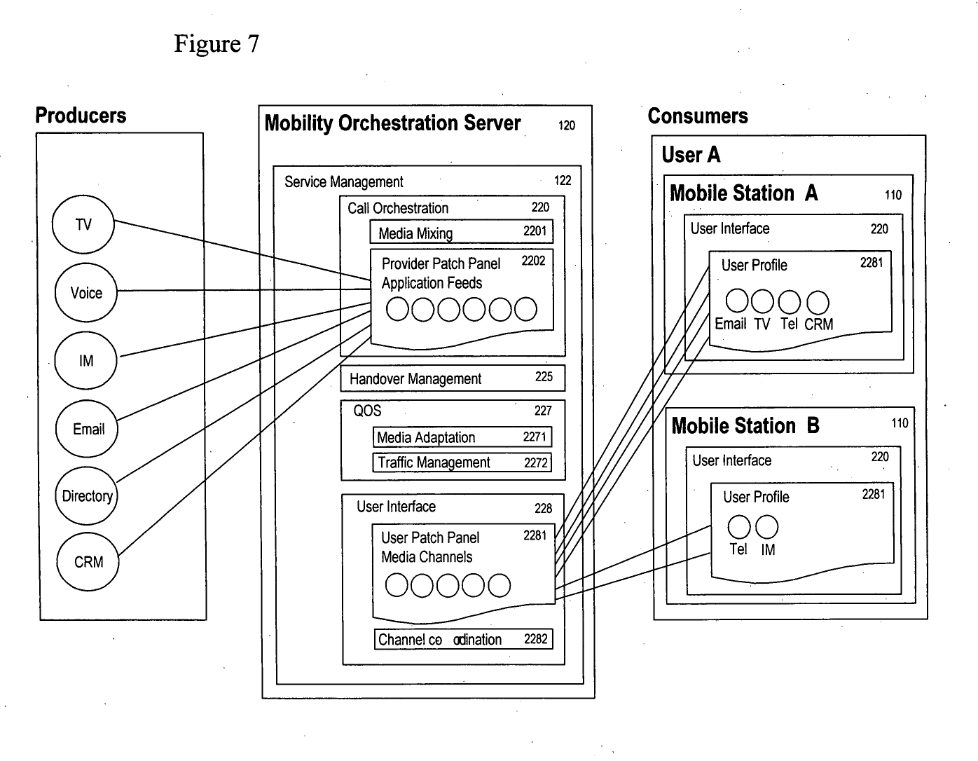

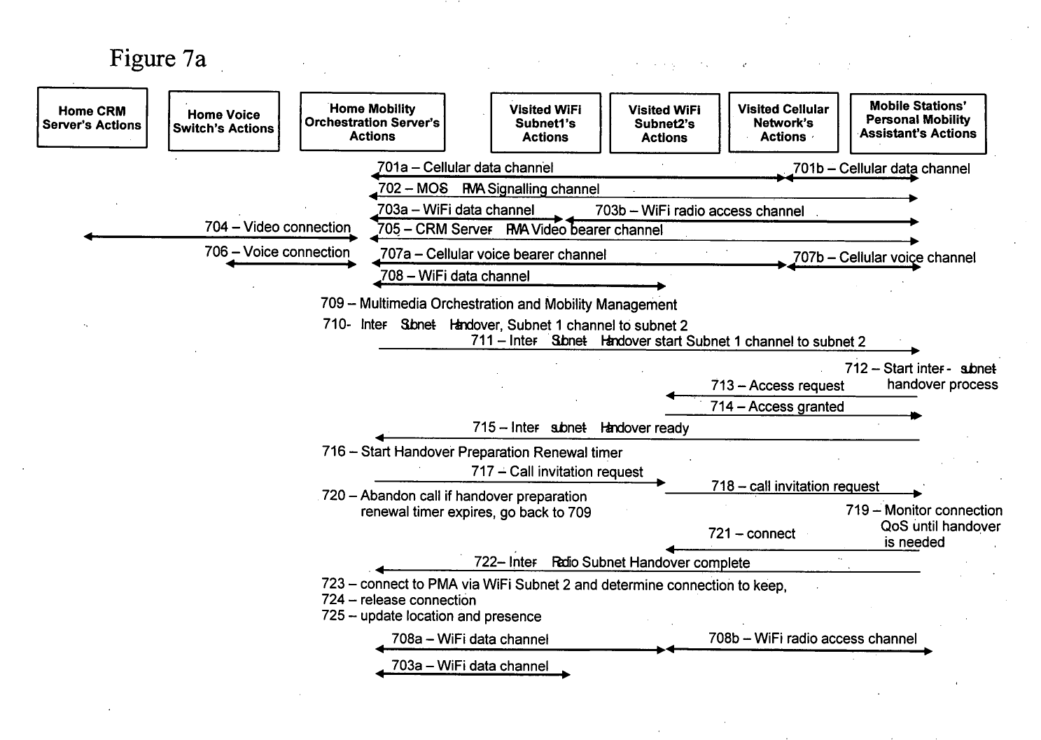

FIG. 7a illustrates a combination signalling sequence chart and flow chart for handing over one of the bearer channels from one radio subnetwork to another radio subnetwork in accordance with an embodiment of the present invention in which a cellular network data channel is used for signalling channel, a cellular voice channel is used for voice bearer channel, and a WiFi connection is used as a video bearer channel to the multimedia device.

### DETAILED DESCRIPTION OF THE PREFERRED EMBODIMENTS

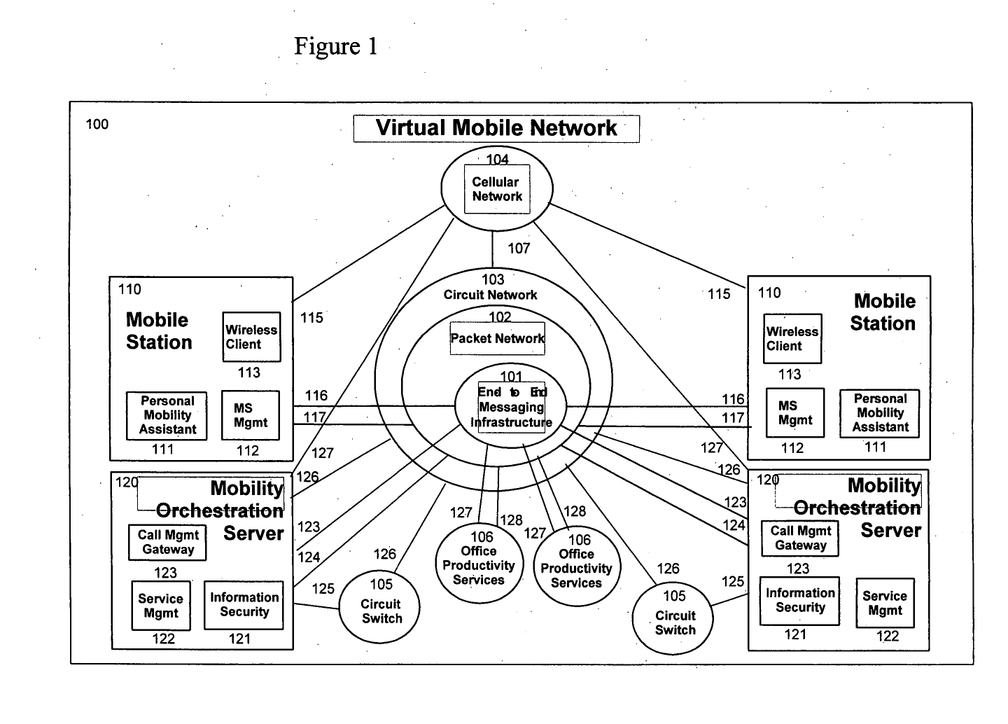

In the high-level diagram of FIG. 1, Virtual Mobile Network system 100 represents the system of the present invention. Several major elements make up this system. First, End-to-End Messaging Infrastructure 101 represents the messaging backbone with which elements of the Virtual Mobile Network communicate. This Infrastructure can be any messaging system that allows users or automatic programs to exchange messages with one another. It is preferably the Internet-standard HyperText Transfer Protocol (Secure) (HTTPS) service, but may also be implemented as an instant messaging service, a wireless short message service (SMS), Internet-standard email service, any other messaging service, or any combination of these. Second, Packet Network 102 forms the foundation for all communication among elements, including End-to-End Messaging Infrastructure 101 and the messages exchanged thereon, but also supporting other non-messaging interactions such as web browsing. This element is preferably an Internet-based network, and may be the Internet itself, another network like it, or a composite of networks using multiple inter-working technologies. Third, Circuit Network 103 represents the network infrastructure with which circuit-based applications communicate. This element may be the Public Switched Telephone Network itself, it may be a circuit switched cellular network, and/or it may be a circuit switched private enterprise network. End-to-End Messaging Infrastructure 101 may also send messages using Circuit Network 103. Forth, Cellular Network 104, a special instant of the Circuit Network 103, is highlighted to outline the special interface 115 to Mobile Station 110.

Connected to End-To-End Messaging Infrastructure 101 and Packet Network 102 is at least one or more Mobility Orchestration Server 120. Each Mobility Orchestration Server comprises of a Call Management Gateway 123, an Information Security module 121, a Service Manager 122, an interface 126 to Circuit Network 103, and an interface 125 to Circuit Switch 105. Mobility Orchestration Server 120, embodies many methods of present invention orchestrating services and capabilities provided by Circuit Switch 105, Office Productivity Service 106, Cellular Network 104, Circuit Network 103, Packet Network 102, End-To-End Messaging Infrastructure 101, and Mobile Station 110 to create a Virtual Mobile Network environment for users. Interface 127 is a standard radio access interface which connects Mobility Orchestration Server 120 as a cellular user to cellular network 104. This interface enables the Mobility Orchestration Server to take advantage of special cellular user tariff rates when communicating with Mobile Station 110.

Also connected to End-to-End Messaging Infrastructure 101 and Packet Network 102 are one or more Mobile Stations 110, which are computer software applications and devices which enable mobile communication. Each Mobile Station is composite of some existing Wireless Client 113, Mobile Station Management 112. It may also contain a Personal Mobility Assistant 111, and an interface 115 to the Cellular Network 104. Standard Wireless Client 113 is responsible for interfacing with various wireless interfaces such as wireless local area networks radios, infra-red devices, special mobile radios, and cellular radios. Standard component Mobile Station Management 112 controls and maintains various mobile station resources such as display, microphone, speaker, memory storage, software operating system resources. Many Wireless Client 113 and Mobile Station Management 112 modules are well-known to those skilled in the art, the present invention make use of such existing modules instead of creating new ones. Personal Mobility Assistant 111, embodies methods of present invention as described below is a new entity. Thus Mobile Station 110 comprises both existing and new technology. In the preferred embodiment, a Mobile Station 110 contains a Personal Mobility Assistant 111 and a Wireless Client 113 which supports both Cellular and WiFi interfaces.

In addition, connected to End-to-End Messaging Infrastructure 101 and Packet Network 102 is one or more Office Productivity Services 106. Office Productivity Service 106 provides various common and standard office services well-known to those skilled in the art, such as enterprise directory, calendar, collaborative computing services, and customer relation management services. Office Productivity Service 106 may be an IP-based Key System service, IP-based Private Branch Echange (IPBX) service, or a Public Carrier hosted or Public Carrier managed IP-based Centrex service. In addition, Office Productivity Service 106 may also be a Customer Relationship Management service using high speed video streaming capability to connect customers to sophisticated computer assisted education applications.

Connected to Circuit Network 103 and Mobility Orchestration Server 120 is one or more Circuit Switches 105. Circuit Switch 105 may be a traditional circuit-based Key System or TDM-based PBX. It may also be a traditional circuit-based Centrex service hosted or managed by a Public Carrier.

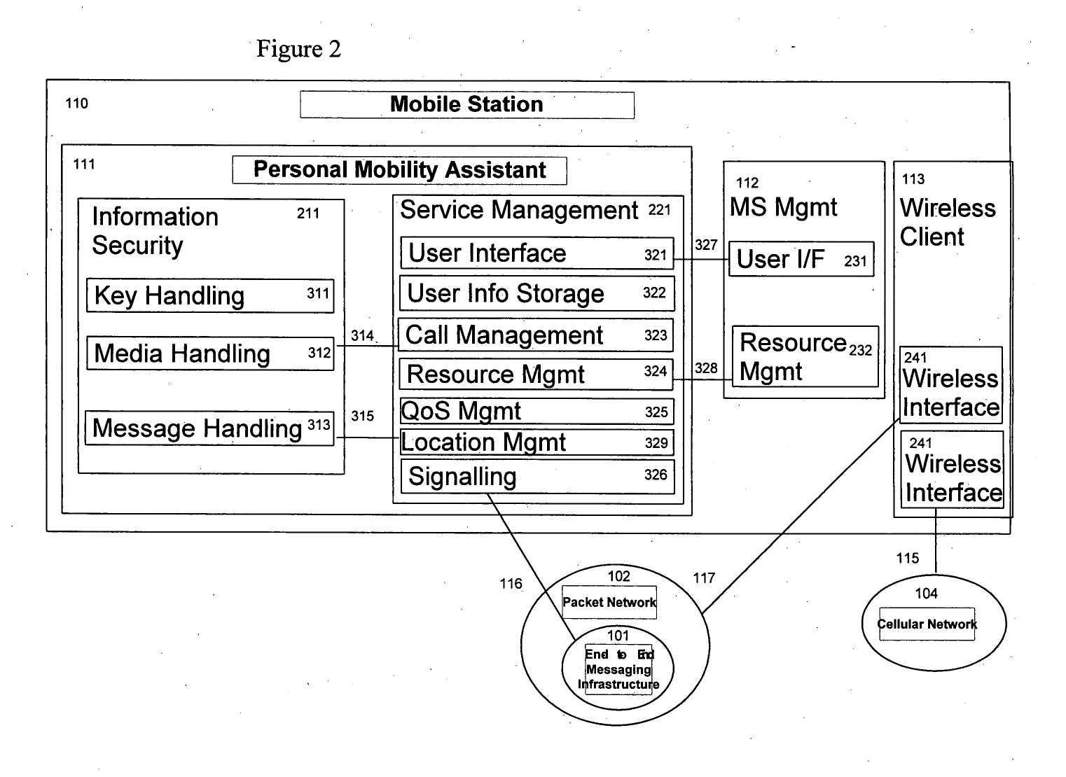

Details on Mobile Station 110 can be found in FIG. 2. Mobile Station 110 comprises a Wireless Client 113, a Mobile Station Management module 112, and a Personal Mobility Assistant 111. Wireless Client 113 contains at least one or more Wireless Interface 241. Wireless Interface 241 can be a Cellular interface such as GSM, GPRS, EDGE, WCDMA, CDMAone, CDMA2000, or any other digital and analogue cellular radio interfaces. It can also be a Wireless LAN interface such as 802.11a, 802.11b, 802.11g, 802.11n, and any other Wireless LAN interfaces. Wireless Interface 241 can be a WiMAX interface such as 802.16, and 802.20. It can also be any other wireless interfaces such as Blue Tooth, ZigBee, and Infrared. Mobile Station Management 112 comprises a User Interface module 231 and a Resource Management module 232. User Interface 231 responsible for receiving commands from the Mobility Orchestration Server and presenting result to the user making use of Mobile Station resources such as display, microphone, and speaker via Resource Management module 232.

Personal Mobility Assistant 111 embodies many methods of the present invention controlled by the Mobility Orchestration Server 120, further comprises Information Security 211 and Service Management 221. Information Security 211 further comprises Key Handling 311, Media Handling 312, and Message Handling 313. Each Mobile Station 110 is configured with a Mobility Orchestration Server 120, known as the Mobile Station's Home Mobility Orchestration Server. Key Handling 311, where in the preferred embodiment uses RSA public-key encryption and signature techniques, well known to those skilled in the art, to perform mutual authentication with its Home Mobility Orchestration Server. It stores the Public Key Certificate assigned to it by the Home Mobility Orchestration Server securely. Media Handling 312, using standard encryption technique to encrypt the media streams of each call. Message Handling 313 employs standard security and encryption techniques to ensure communication with Mobility Orchestration Servers 120 is secure. Service Management 221 further comprises User Interface 321, User Information Storage 322, Call Management 323, Resource Management 324, Quality of Service Management 325, and Signalling module 326. User Interface 321 receives commands from Mobility Orchestration Server and relays that to the Mobile Station Management 112 via Interface 327. It relays user response from Mobile Station Management 112 via Interface 327 to Mobility Orchestration Server. User Information Storage 322 stores all user specific information such as user preferences, Mobile Station 110 capabilities, and call log information required by Personal Mobility Assistant's 110 operation. Call Management 323 maintains states of active calls and coordinates with Mobility Orchestration Server 120 on call and feature interaction activities. It also gains access to Mobile Station 110 resources via Resource Management 324. Resource Management 324 makes Mobile Station resources available to other components of Personal Mobility Assistant 111 via Interface 328 to Mobile Station Management 112. Quality of Service Management 325, monitors and maintains optimal quality of the connections. Quality of Service Management 325 collects information on jitter, delay, Mean Opinion Score, and radio signal strengths on connections and determine in conjunction of Quality of Service Management 227 of Mobility Orchestration Server 120 to decide when the quality of an active connection is unacceptable and triggers a handover. As the Mobile Station 10 roams, the Location Management module 329 collects signal strength information, the Location Area Identity (LAI) code containing the Mobile Country Code (MCC), Mobile Network Code (MNC), and the Location Area Code (LAC), from the wireless interface module 241 connected to the GSM cellular network. Signal strength and equivalent location area identity code in other cellular networks such as CDMA and WCDMA networks are also collected through the wireless interface modules 241 connecting to those networks. The Location Management module 329 also collects WiFi Access Point address and signal strength information as the Mobile Station 110 roams through a WiFi network. This location and signal strength information is sent to the Mobility Orchestration Server as the Mobile Station roams. Signalling module 326 provides protocol support for interacting with End-to-End Messaging Infrastructure 101 via interface 116; this is where, in the preferred embodiment based upon HTTPS for example, the Internet-standard HyperText Transfer Protocol (Secure) would be implemented.

The preferred embodiment of a Mobile Station 110 is a WiFi and Cellular dual mode smart phone. However, a Mobile Station 110 can also be a Personal Computer (PC), a Personal Digital Assistant (PDA), a single mode WiFi phone, a single mode cellular phone, a Blue Tooth device, a Zigbee device, an Infrared device, and an Unlicensed Mobile Access (UMA) compliant WiFi and cellular dual mode phone or a combination of the above-mentioned devices.

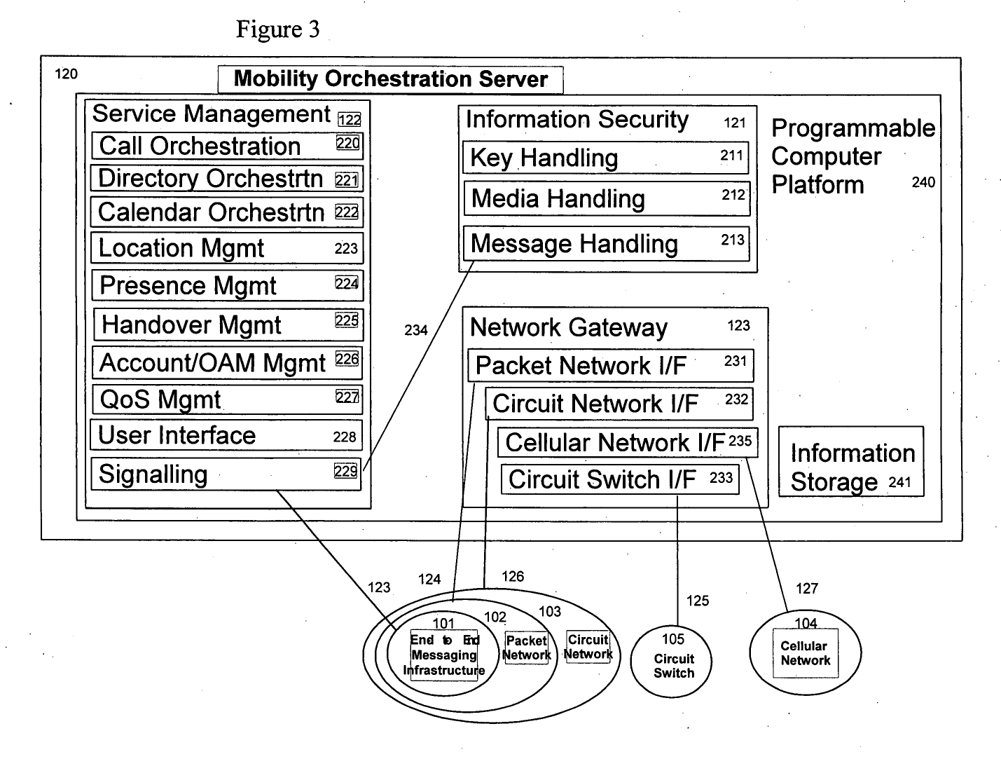

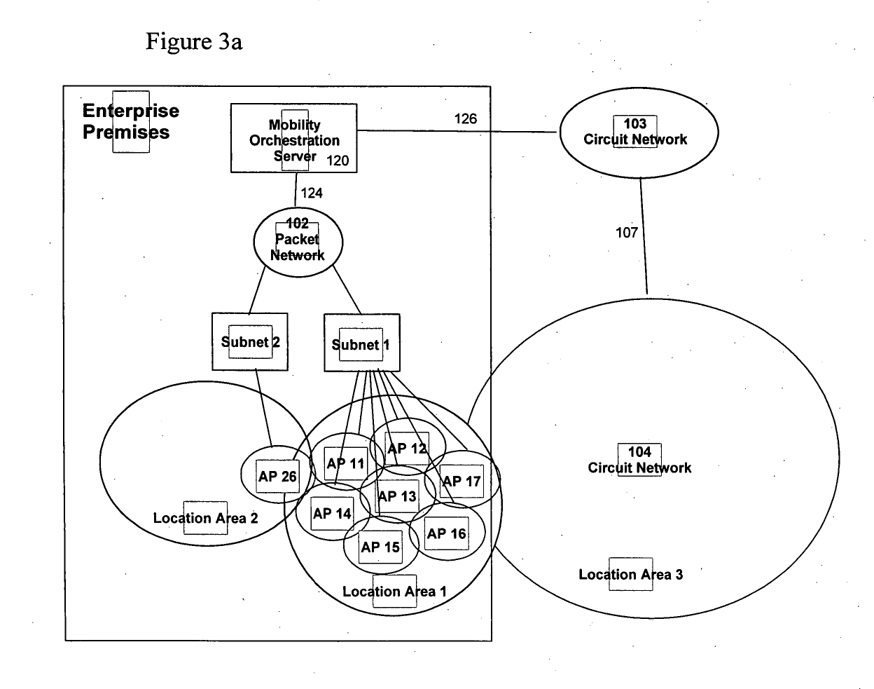

FIG. 3 outlines details of a Mobility Orchestration Server 120. Mobility Orchestration Server 120 comprises Information Security 121, Service Management 122, Network Gateway 123, and Information Storage 241 implemented on a programmable computer platform 240. Information Security 121 further comprises Key Handling 211, Media Handling 212, and Message Handling 213. Key Handling 211, where in the preferred embodiment uses RSA public-key encryption and signature techniques, well known to those skilled in the art, to perform mutual authentication with Personal Mobility Assistants 111 requesting services. It generates, stores, and distributes Public Key Certificate assigned to each Personal Mobility Assistant 111. It is also responsible for re-certification and un-certification of Mobile Stations. Media Handling 212 uses standard encryption techniques to encrypt media streams of each secure call. Message Handling 213 employs standard security and encryption techniques to ensure communication with Personal Mobility Assistant 111 is secure.

Network Gateway 123 further comprises Packet Network Gateway 231, Packet Network Interface 231, Circuit Network Interface 232, Circuit Switch Interface 233, and Cellular Network Interface 234. Packet Network Interface 231 using standard packet network protocol interfaces 124 such as TCP/IP over Ethernet to connect to Packet Network 102. Circuit Network Interface 232, connects to Circuit Network 103 with standard circuit network interfaces 126 such as T1, E1, ISDN PRI, ISDN BRI, FXO, and many other standard analogue and digital circuit network interfaces well known to the skilled in the art. Circuit Switch Interface 233, connects to Circuit Switch 105 using industry standard Computer Telephony Interfaces (CTI) 125 such as TAPI and CSTA. PBX manufacturer specific CTI interfaces such as the Meridian Link from Nortel and CorNet interface from Siemens and other PBX manufacturers CTI interfaces can also be used. Cellular Network Interface 235, connects to Cellular Network 104 using industry standard radio interfaces such as GSM, GPRS, EDGE, WCDMA, CDMAone, and CDMA2000. There are numerous add-on computer processing cards, well known to those skilled in the art, which implement the above described network interfaces. The preferred embodiment of Network Gateway 123. is to use these add-on computer processing cards on Programmable Computer Platform 240.

Service Manager 122 further comprises Call Orchestration 220, Directory Orchestration 221, Calendar Orchestration 222, Location Management 223, Presence Management 224, Handover Management 225, Account and OAM Management 226, QoS Management 227, User Interface 228, and Signalling module 229.

In a preferred embodiment, Call Orchestration 220 coordinates calls from Internet Packet Network 102, Cellular Circuit Network 103 and Enterprise PBX Circuit Switch 105. It also decides which of the Network Gateway 123 interface is to use when processing call handovers and outgoing calls. Its interactions with other components of the system will become clear as the methods of the present invention are explained below. Directory Orchestration 221, takes directory access requests from Personal Mobility Assistant 111, compiles and translates the requests into appropriate requests for the Directory system resident in Office Productivity Service 106 using End-to-End Messaging Infrastructure 101. It also takes data from the Directory service resident in Office Productivity Service 106, compiles, translates and organized for Personal Mobility Assistant 111 using User Interface 228. The messages can travel through any of the appropriate Interfaces in Network Gateway 123. In the preferred embodiment, appropriate Directory information is cached in Information Storage 242 to optimize the access performance. The interactions of Directory Orchestration 221 with other components of the system will become clear as the methods of the present invention are explained below.

Calendar Orchestration 222, takes calendar access and update requests from Personal Mobility Assistant 111, compiles and translates the requests into appropriate requests for the Calendar system resident in Office Productivity Service 106 using End-to-End Messaging Infrastructure 101. It also takes data from the Calendar service resident in Office Productivity Service 106, compiles, translates and organized for Personal Mobility Assistant 111 using User Interface 228. The messages can travel through any of the appropriate Interfaces in Network Gateway 123. In the preferred embodiment, appropriate user specific Calendar information is cached in Information Storage 242 to optimize the access performance. The interactions of Calendar Orchestration 222 with other components of the system will become clear as the methods of the present invention are explained below.

Location Management 223 tracks the locations of users. FIG. 3a introduces the concepts of Location Areas and handover boundaries. All wireless Access Points belong to the same subnet are organized into a Location Area. In this illustration, all Access Points are organized into two Location Areas, Location Area 1 and Location Area 2. Within Location Area 1 there are seven Access Points, AP11 to AP17. AP13 is in the interior of Location Area 1 and is known as an Interior Access Point while AP11, AP12, AP14, AP15, AP16 and AP17 are at the edge of Location Area 1 and are thus known as Edge Access Points. Location Area 3 is used to identify a Cellular Network next to Location Area 1. The Edge Access Points mark the boundary between Location Areas and is key to Inter-Subnet and Inter-Network handovers. As user is authenticated by Key Handling 211 and when location information is reported by the Mobile Station 110, the location of the user is relayed to Location Management 223. User location information is represented by a number of information elements such as radio signal strength, Location Area Identifier (LAI) of a cellular network radio cell and IP address of the Access Point. User location information is stored in Information Storage 242. Location Management 223 also works with Directory Orchestration 220 to incorporate location information on the Directory information presented to users accessing the Directory.

Since standards and many implementations for intra-subnet handover exist, present invention presents an Autonomous and Predictive handover method to handover calls between subnets and between networks. Location Management 223 keeps a history of the radio signal strength and locations traversed by a user to form a Personal Virtual Mobile Network topology for the user. This history of locations traversed by a user while active on a call is captured and developed into a predicted path of travel, based on which in conjunction with location area boundary information, predictive inter-subnet and inter-network handover processes can be triggered. Handover Management 225, controls the handover activity when an active call or a bearer channel of a multimedia active call, needs to be handover from a subnet to another subnet or an active call needs to be handover to a different network for example from a Circuit Switch 105 to a Cellular Network 104. The Autonomous and Predictive Handover method comprises trigger, preparation, and handover steps. Handover can be triggered by Handover Management 225 receiving a handover request from QoS Management 227 as a result of detecting unacceptable quality of service. It can also be triggered when a user carries an active call enters into an Edge Access Point with a predicted path of travel towards the edge of a location area. Once handover is triggered, Handover Management 225 prepares for handover. At least one Target Location Areas is identified for each handover. In conjunction with Personal Mobility Assistant 111 and Call Orchestration 220, at the appropriate time based on some predictive probability of when the user is about to cross the handover boundary, Handover Management 225 initiates call connections via identified Target Location Areas to Mobile Station 110 ready for handover. If the handover is determined to be between networks, Handover management 225 looks up the network number to be connected from the user's preference information from Information Storage 242. A call connection is established using the appropriate interface from Network Gateway 123 to Mobile Station 110. Note that in the preferred embodiment both existing and new connection would terminate on the same dual mode Mobile Station 110, however, this will also work when the existing connection and the new connection terminate on separate Mobile Station 110, such as in the case of handover a call from a single mode WiFi handset to a single mode cellular handset. As Handover Management 225 initiates the handover preparation connection, a timer is started to control when the existing handover preparation connection need to be abandoned and a new handover preparation connection need to be established. After the handover preparation is initiated, Mobile Station 110 monitors the QoS of the existing connection, if the QoS thresh hold is crossed, it accepts the handover preparation connection and cut over the media path. Once the new connection is established and stable, if both connections are still available, a quality of service comparison is done between the new connection and the old connection and the inferior connection is dropped, thus completed the handover. If the handover is between radio subnets and Mobile Station 110 has only one Wireless Interface 241 with limited capabilities accessing both the existing radio subnet and the new radio subnet, radio signal strength tests on both radio subnet will be done by Call Management 323 of Personal Mobility Assistant 111 and determines which radio subnet is to be used and a hard handover is executed between Call Management 323 of Mobile Station 110 and Handover Management 225

Presence Management 224 captures user current presence activity information such as active on a call. If the Office Productivity Service 106 has Presence service support, Presence Management 224 may receive presence information from Office Productivity Service 106. It also takes user presence update requests from Personal Mobility Assistant 111. If Office Productivity Service 106 supports Presence service, it sends all presence updates to Office Productivity Service 106. User presence information is stored in Information Storage 242. Presence Management 224 also works with Directory Orchestration 220 to incorporate presence information on the Directory information presented to users accessing the Directory.

Account and OAM Management 226, manages user account information and Mobility Orchestration Server network configuration, operation and maintenance activities. User account information contains user preference information and operating data specific to the user such as the Personal Mobility Assistant 111 identification, public keys and certificate data associated with the Personal Mobility Assistant 111, Mobile Station 110 capabilities, the associated Home Mobility Orchestration Server 120 identification, cellular number, office business number, presence data, and personal calendar information. Account and OAM Management 226 also keeps a network view of all Access Points to Location Areas mapping. The usual OAM data and associated operations well know to those skilled in the art will also be maintained. In the preferred embodiment, Account and OAM Management 226 will be implemented with a web browser to facilitate easy access by end users to update the user account information and to facilitate easy access by operators to effect OAM management of the Mobility Orchestration Server 120 network.

Quality of Service Management 227, monitors and maintains optimal quality of service for all connections. Quality of Service Management 227 collects information on jitter, delay, Mean Opinion Score, and radio signal strength to gauge the Quality of Service on the connections. Based on the quality service thresh-holds associated with different types of connections, Quality of Service management 227 initiates handover preparation activities with Personal Mobility Assistant 110 and triggers handover request to Handover Management 225. Quality of Service Management 227 also renegotiates connection speed with Quality of Service Management 325 of Personal Mobility Assistant 110 when the handover will result on a connection with different bandwidth then the existing connection.

User Interface 228 manages presentation information from other components of Service Management 122, Information Security 121, and Network Gateway 122 designated for the user in conjunction with User Interface 321 of Service management 221 of Personal Mobility Assistant 111 of Mobile Station 110.

Programmable Computer Platform 240 is chosen to provide highly reliable operation and flexible scalability. Candidates satisfying such requirements are well-known to those skilled in the art, and are available from major vendors such as SUN, HP, Motorola, and Intel. Programmable Computer Platform 240 also includes an Information Storage medium 241, for holding the data required by components Information Security 121, Service Management 122, and Network Gateway 123. This is typically implemented as a magnetic “hard disk” module.

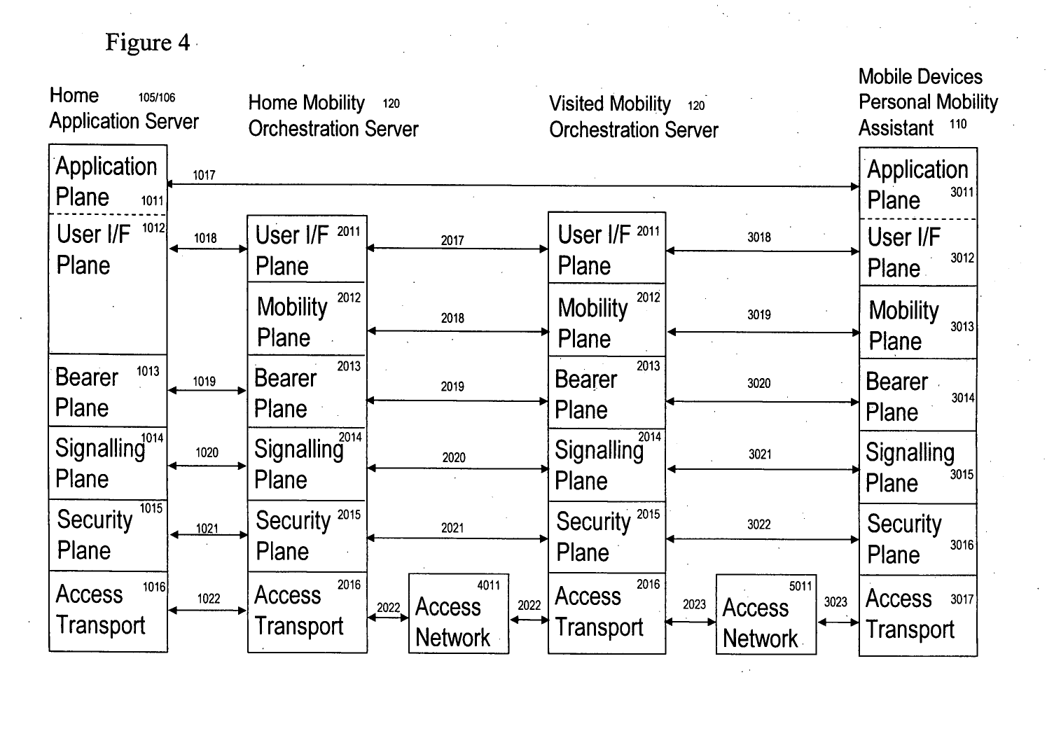

FIG. 4 depicts the protocol architecture used between network elements in the Virtual Mobility Network. In that Access Transport 4011 and 5011 can be Cellular Network 104, Circuit Network 103, Packet Network 102, or end-end Messaging Infrastructure 101 and Home Application Server can be Circuit Switch 105 or Office Productivity Services 106. This protocol architecture enables the transparent addition of mobility management to fixed networks elements such as Circuit Switch 105 and Office Productivity Services 106, designed to support only fixed location users such as a fixed location desktop telephone and desktop computer. It facilitates the implementation of stronger security measures to existing security systems accounting for mobile devices. It also allows the more flexible and economic use of network resources by decoupling always on signalling channel from on demand bearer channels.

The Virtual Mobility Network Protocol Architecture has seven distinct layers and is implemented in the Personal Mobility Assistant with Access Transport 3017, Security Plane 3016, Signalling Plane 3015, Bearer Plane 3014, Mobility Plane 3013, User Interface Plane 3012 and Application Plane 3011. Access Transport 3017 is responsible for establishing and maintaining transport channels with Access Network 5011 using interface 3023. There may be multiple interface 3023 simultaneously, one for Signalling Plane 3015 and others for multiple Bearer Plane 3014. Security Plane 3016 is responsible for certification, authentication, securing, detecting and mending security breaches of the interface 3022 with the Mobility Orchestration Server 120. Signalling plane 3015 is responsible for establishing and maintaining a signalling channel with Mobility Orchestration Server 120. This channel is opened at all time when Mobile Station 110's powered is switched on. The Bearer Plane 3014 is responsible for establishing and maintaining bearer channels with Mobility Orchestration Server 120 on as needed basis. There may be multiple interface 3020 simultaneously, one for each service requiring a separate bearer channel. Each of these Bearer channels may be supported by different Access Network 5011. The Mobility Plane 3013 is responsible for collecting radio signal strength information, mobility and location data such as Location Area Identity (LAI) in GSM network and Access Point address information in a WiFi network, to report to Mobility Orchestration Server 120 using interface 3019. User Interface Plane 3012 is responsible for receiving user interface information from Mobility Orchestration Server 120, interpreting the information and presenting the information to the user. It is also responsible for receiving input from the user and relaying that to the Mobility Orchestration Server 120 using interface 3018. Since many user interface issues are tightly coupled with specific applications, the layering between User Interface Plane 3012 and Application Plane 3011 is represented by a dotted line to indicate that some User Interface Plane 3012 elements are tightly coupled with some specific applications in Application Plane 3011. Application Plane 3011 is responsible for establishing and maintaining interface 1017 towards Application Plane 1011 of Application Server such as Circuit Switch 105 and Office Productivity Services 106. For example, in the case of a Circuit Switch 105, a voice communication application in Application Plane 3011 is responsible for establishing and maintaining a voice call connection with the voice communication application in the Application Plane 1011 of the Circuit Switch 105 using interface 1017.

The Mobility Orchestration Server 120 implements six of the seven Virtual Mobile Network protocol layers: the Access Transport 2016, Security Plane 2013, Signalling Plane 2014, Bearer Plane 2013, Mobility Plane 2012, and User Interface Plane 2011. Access Transport 2016 is responsible for establishing and maintaining transport channels with Access Network 5011 using interface 3023 towards Mobile Station 110 using interface 2023, with Access Network 4011 towards other Mobility Orchestration Server 120 using interface 2022, or with an Application Server, such as a Circuit Switch 105 or an Office Productivity Service 106, using interface 1022. There may be multiple interface 2023 simultaneously, one for Signalling Plane 2014 and others for multiple Bearer Plane 2013 towards a single Mobile Station 110. There may be multiple interface 2023 simultaneously for multiple Mobile Stations 110. There may be multiple interface 2022 connecting to multiple Mobility Orchestration Servers 120. There also may be multiple interface 1022 connecting to multiple Application Servers. The Access Transport 2016 is responsible for establishing and maintaining transport connections to all Mobile Stations 110, other Mobility Orchestration Servers 120, and all Application Servers such as Circuit Switch 105 and Office Productivity Services 106. The preferred embodiment of interface 2022 towards other Mobility Orchestration Servers 120 is standard secured Internet access such as HTTPS. The preferred embodiment of interface 2023 towards Mobile Stations 110 for the signalling channel is via a Cellular Network 104 as the Access Network 5011 using standard secured Internet access such as HTTPS. The preferred embodiment of interface 1022 towards other Office Productivity Services 106 is standard IP interface. When connecting to Circuit Switch 105, interface 1022 will likely be a standard TDM or analogue interface with special adaptation for the specific Circuit Switch 105. Security Plane 2015 is responsible for certification and authentication of Mobile Stations 110, Mobility Orchestration Server 120 and other Virtual Mobility Network elements. This is where the Cellular equivalent of Authentication Centre (AUC) is implemented. It is responsible for securing communication information, detecting and mending of security breaches of interface 2023, interface 2022 and interface 1022. It is also responsible for mediating between Security Plane 1015 of the Application Server and Security Plane 3016 of the Mobile Station 110. For example, if Security Plane 1015 of the Application Server requires security clearance from Mobile Station 110 to gain access to the application, Mobile Station 110 only has to register and clear security with Security Plane 2015 once without explicit clearance with Security Plane 1015 of the Application Server. Security Plane 2015 of Mobility Orchestration Server does the register and clear security requirements on behalf of Mobile Station 110 with the Application Server. Signalling Plane 2014 is responsible for establishing and maintaining a signalling channel with every registered Mobile Station 110 using interface 3021. This signalling channel is active at all time as long as the Mobile Station 110 power is on. It is responsible for establishing and maintaining signalling interface 2020 to other Mobility Orchestration Servers. It is also responsible for establishing and maintaining signalling interface 1020 to other Application Servers such as Circuit Switch 105 and Office Productivity Services 106. All these signalling interfaces are established as soon as the network elements are powered on and maintain active as long as the power supplies of these network elements are on. Bearer Plane 2013 is responsible for establishing and maintaining all Bearer interfaces 3020 towards all Mobile Stations 110 on as needed basis. These Bearer interfaces 3020 may be narrow band cellular radio interface, wideband WiFi radio interface, Blue Tooth radio interface or other standard wireless and wired interfaces. It is responsible for establishing and maintaining Bearer interface 1019 towards Application Server such as Circuit Switch 105 and Office Productivity Services 106 on as needed basis. It is also responsible for establishing and maintaining Bearer interface 2019 towards other Mobility Orchestration Servers 120 when needed. The preferred embodiment of Bearer Interface 2019, when needed, is standard secured Internet interface such as HTTPS. Mobility Plane 2012 is responsible for collecting location and signalling information from Mobile Station 110. It builds and maintains a Personal Virtual Mobility Network topology for each Mobile Station 110 based on the signalling and location information collected from each Mobile Station 110. This is where the 2G Cellular equivalent of Home Location Register (HLR), Visited Location Register (VLR), and 3G Cellular equivalent of Home Subscriber System (HSS) is implemented. It tracks location movements of Mobile Station 110 and determining when handover is required based on the Predicted Path Of Travel of Mobile Station 110 across the corresponding Personal Virtual Mobile Network. It is also responsible for establishing and maintaining interface 2018 towards other Mobility Orchestration Server 120. When Mobile Station 110 roams into a foreign Mobility Orchestration Server 120 area, say in Paris France, and attempts to register with the home Mobility Orchestration Server 120, say in New York City, the home Mobility Orchestration Server, based on the location information collected from Mobile Station 110, will use interface 2018 to request the Mobility Orchestration Server 120 in Paris to support visiting Mobile Station 110. After Mobile Station 110 registered with the visited Mobility Orchestration Server 120 information of visiting Mobile Station 110's activities is relayed back to the home Mobility Orchestration Server 120 using interface 2018. Notice that there is no Mobility Plane required on the Application Servers such as Circuit Switch 105 and Office Productivity Services 106. User Interface Plane 2011 is responsible to establishing and maintaining a logical interface 3018 on top of Signalling interface 3021 towards Mobile Station 110. Interface 3018 can be standard or proprietary mobile station control interfaces such as J2ME, BREW, Symbian, Windows Mobile, WAP or other standard or proprietary mobile station interface control protocols. User Interface Plane 2011 is responsible for establishing and maintaining a logical interface 1018 on top of Signalling interface 1020 towards Application Servers such as Circuit Switch 105 and Office Productivity Services 106. User Interface Plane 2011 is also responsible for mediating between User Interface Plane 1012 of Application Server and User Interface Plane 3012 of Mobile Station 110. A set of virtual terminal user interface command elements are defined as part of interface 1018 to enable Application Servers such as Circuit Switch 105 and Office Productivity Services 106 to drive the user interface on Mobile Station 110 without knowing the specific interface 3018 requirements.

FIG. 5 depicts an implementation embodiment of a Virtual Mobile Network using a GSM cellular network 104 as access network. Mobile Station 110 is connected to the GSM Cellular Network 104 with a dedicated Signalling Interface 326 using GPRS Interface 116 to the GSN data node 1042 of the GSM Cellular Network 104 and on demand Voice bearer channels 241 using GSM radio interface 115 to the GSM voice switch 1041. The Signalling Interface 229 of Mobility Orchestration Server 120 is connected to the GSN data node 1042 of the GSM Cellular Network 104 with an Internet interface 123. The Voice Bearer Interface 235 of Mobility Orchestration Server 120 uses a GSM radio interface 127 to the Mobile Station via the GSM voice switch 1041 of GSM Cellular Network 104. Voice Switch 105 is an IP switch and connected to the Voice Switch Interface 233 of Mobility Orchestration Server 120 with an SIP IP interface 125. Inside the Voice Switch 105 a User Profile is stored defining the features and characteristics of the services supported by the Voice Switch 105 that the user has permission to access. Information Storage 241 of Mobility Orchestration Server 120 also stores a User Profile defining the features and characteristics of the services supported by the Mobility Orchestration Server 120 that the user has permission to access. When Mobile Station 110 registers with the Mobility Orchestration Server 120 using the GPRS interface 116, the Mobility Orchestration Server 120 registers with the Voice Switch 105 on behalf of the user. Feature access requests from Mobile Station 110 are served by Mobility Orchestration Server if they are supported by the Mobility Orchestration Server, otherwise the request is passed over to the Voice Switch for process. More detailed feature support interactions can be found in FIG. 5b.

FIG. 6 depicts a number of Personal Virtual Mobile Networks overlay on top of a corporate Virtual Mobile Network. In this example, the enterprise has a head quarter and a branch office. The head quarter is served by a Mobility Orchestration Server A 120 and a cellular network A 104 with a cellular cell C1 1041 covering the general premises. Inside the head quarter premises, there are two WiFi subnets, Subnet 1 and Subnet 2. WiFi Subnet 1 has radio cells W1, W2, and W3 while WiFi Subnet 2 has radio cells W4, W5, and W6. A Blue tooth radio cluster with radio cell B1, B2, and B3 is also installed inside the head quarter premises. All WiFi and Blue Tooth radio cells have overlapping regions with the Cellular Cell C1. The head quarter also has an IP voice switch 106 supporting some IP phones. The branch office in a different geographic area is served by a Mobility Orchestration Server B 104 and a different cellular network B 104 with cellular cell C2 1041 covering the general premises of the branch office. The branch office is also covered by a WiFi subnet 3 with overlapping coverage area with the cellular cell C2. An IP voice switch 106 is also installed in the branch office. So the enterprise Virtual Mobile Network is comprise of Cellular Network A 104 , Cellular Network B 104, WiFi subnet 1, WiFi subnet 2, WiFi subnet 3, the Blue Tooth network in the head quarter, and all the IP phones. The enterprise Virtual Mobile Network is managed by Mobility Orchestration Server A in the head quarter and Mobility Orchestration Server B in the branch office.

Here we observe three different Personal Virtual Mobile Network overlays created by three different users: user A, user B, and user C. User A only has a single mode cellular mobile station. He has registered with the Mobility Orchestration Server A 120 only via the cellular cells of the Cellular Network A 104. User A's Personal Virtual Mobile Network is Cellular Network A. User B has a Cellular and Blue Tooth dual mode phone, he has subscribed to Cellular Network A and Cellular Network B service. He has registered from or roamed into various cellular cells from both cellular networks and all the Blue Tooth radio cells with the Mobility Orchestration Servers. User B's Personal Virtual Mobile Network comprise of both cellular networks and the Blue Tooth radio cluster. He can roam and carry active calls across the Blue Tooth and Cellular boundaries. User C has an IP phone P1 and a WiFi and Cellular dual mode mobile station. He has subscribe to both Cellular Network A and Cellular Network B and has permission to access WiFi Subnet 1 and WiFi subnet 3. The current Personal Virtual Mobile Network for User C comprise of Cellular Cell C1 of Cellular Network A, Cellular Cell C2 of Cellular Network B, WiFi subnet 1 radio cells W1 and W2, WiFi subnet 3 radio cell W7 and IP phone P1, because those are the cells User C's Mobile Station 110 have registered and roamed into. User C's Personal Virtual Mobile Network will continue to change as User C roams through the areas. However, because User C does not have access permission to the Blue Tooth radio cluster, even if he has a Blue Tooth and Cellular dual mode Mobile Station, User C's Personal Virtual Mobile Network will not include the Blue Tooth radio cells.

FIG. 7 depicts a Multimedia system Orchestration Architecture which decouples multimedia service providers from multimedia service users to enable systematic value added services and capabilities to be added to the services. This architecture is modeled upon the “patch panel” paradigm where there are two separate “patch panels” in the system, one for service providers to “plug-in” and connect their services to the system, another for users to “plug-in” their user devices to connect to the services they have permission to access. A user can “plug-in” multiple devices of different capabilities to the user's personal “patch panel”. This architecture also follows the producer-consumer concept used heavily in the Service Oriented Architecture (SOA) where the producer is decoupled from the consumer to facilitate independent development, deployment and evolution of each. One of the key value added this architecture facilitates is the systematic organization and management of transferring all or part of the connections from one network to the other in the event that a handover is required. In the sample implementation of this architecture depicted in FIG. 7, the Mobility Orchestration Server 120 separates the producers such as and TV program producer, a voice switch, an Instant Messaging server, an Email server, a directory server, and a Customer Relationship Management service server, from the consumer namely the user using multiple Mobile Stations 110. For example, Mobile Station A 110 is capable of accessing Email, TV, Telephone connections, and Customer Relationship Management service connections, and Mobile Station B 110 supports only Telephone and Instant Messaging connections. The Producer Patch Panel 2202 is implemented as part of Call Orchestration 220 of Service Management 122 in Mobility Orchestration Serverl2O. Where multiple service providers can connect to the system. Each of these connects may employ common standard interfaces such as HTTP or SIP over IP connections or requires special proprietary interfaces such as proprietary PBX feature access protocol over TDM connections. As part of Call Orchestration 220, features such as Media Mixing 2201 can be implemented to mix multiple channels to create new channels on the Provider Patch Panel. For example, the video signals of multiple TV channels can be multiplexed onto a screen of multiple windows with multiple audio subchannels. The User Patch Panel 2281 is implemented as part of User Interface 228 of Service Management 122 in Mobility Orchestration Server 120. Each user has at least one of these User Patch Panels 2281 representing the different channels that the user has permission to access. A user can connect multiple devices to the User Patch Panel 2281 and multiple devices can connect to the same channel simultaneously. For example, Mobile Station A 110 and Mobile Station B 110 both have a connect to the Telephone connector on the User Patch Panel 2281 in FIG. 7. This enables extension capabilities for services, such as extension phone service, without modifying the producers. Channel Co-ordination 2282 is implemented as part of User Interface 228 to manage a single device connecting to multiple channels, multiple devices connecting to a single User Patch Panel 2281, and multiple devices connecting to a single channel. Handover Management 225 is implemented as part of Service Management 122 in Mobility Orchestration Server 120, to detect and manage handover of a single, several, or all active connections connected to a Mobile Station 110, from network A to network B. It works with Quality Of Service 227 to ensure quality of service is maintain through out the handover activities. Media Adaptation 2271 is exercised when the access capability of receiving network B is different from the sending network A. It is also used when the media channel characteristic of the user Mobile Device 110 using is different from the media channel characteristics of the provider's media channel. Traffic Management 2272 uses techniques such as throttling and load balancing, well known to the skilled in the art, to manage the traffic flow between producers and consumers to ensure Quality Of Service is consistent with what the users expect. This architecture enables other value added features and services to be added to the complex mobile multimedia environment systematically and easily.

FIG. 5a outlines the method of establishing a signalling channel between Personal Mobility Assistant 111 and Mobility Orchestration Server 120 using a Cellular data channel as access transport. It also depicts the method of on demand bearer channel is established using a cellular voice channel as access transport to service an incoming call on a voice switch 105 for the user. The method starts with step 503 after the cellular data channel has been established between the Mobile Station 110 and the Cellular network 104. The cellular data channel can be a GSM GPRS channel connecting to the GSN node in the GSM network. Similar access and termination, well known to the skilled in the art, is used for other access networks such as a CDMA or WCDMA cellular network. To prepare for step 503 once the cellular data channel connected message 502 is received, Personal Mobility Assistant 111 retrieves the Personal Mobility Assistant's Identification address and the Home Mobility Orchestration Server's identification address, composes a Registration Request message, and signs it with the Private Key of the security certificate assigned to it by the Home Mobility Orchestration Server 120 at the time the Personal Mobility Assistant 111 was initialized and configured. In the preferred embodiment, both Mobility Orchestration Server and Personal Mobility Assistant identification addresses follows the structure of a Uniform Resource Identifier (URI). It also captures the Location Area Identifier (LAI) and the International Mobile Subscriber Identifier (IMSI) associated with the current cellular data connection. The message is addressed, through the GSM GSN node to the Home Mobility Orchestration Server 120. The Home Mobility Orchestration Server upon receipt of the Registration Request message 503, executes step 504 to authenticate the Personal Mobility Assistant 111. It first retrieves the Personal Mobility Assistant's identification address from the message, retrieves the associated public key from Information Storage 241, and decrypts the message. If the decryption succeeds, the Personal Mobility Assistant 111 is authenticated and access is granted. In step 505, it then updates the location register with the user's new location information. In step 506, it updates the Personal Virtual Mobile Network topology for the user based on the location information received. It adds the new location to the user's Personal Virtual Mobile Network, if the Location Area Identifier is not already part of the Personal Virtual Mobile Network. The Personal Virtual Mobile Network topology is also updated with location and radio signal strength information received from the user as the user roams. The broader Virtual Mobile Network topology is also updated if necessary. Then one of branch 507 and 508 is taken based on the lost-mobile flag associated with the Personal Mobility Assistant 111. Branch 507 is taken if the Mobility Orchestration Server 120 found that the Personal Mobility Assistant 111 is marked as lost by the lost-mobile flag. Branch 508 is taken if the Mobility Orchestration Server 120 found that the Personal Mobility Assistant 111 is not marked as lost by the lost-mobile flag. The lost-mobile flag can be set by the system administrator when the user reports that the mobile is lost. A web-interface can also be provided to allow the user to set the lost-mobile flag to disable the mobile as soon as the user realizes that the mobile has been lost.

If branch 507 is taken, the Mobility Orchestration Server 120 sends a signed 5071 Device Lockup message to the Personal Mobility Assistant 111 to initiate the lockup of the Mobile Station 110. Upon receipt of 5071—Device Lockup message, the Personal Mobility Assistant 111 executes step 5072 to authenticate the Mobility Orchestration Server 120. It decrypts message 5071 with the Mobility Orchestration Server's 120 public key received at the time the Personal Mobility Assistant 111 was first configured. If the decryption succeeds, the Home Mobility Orchestration Server is authenticated. Upon successful authentication, it executes step 5073 to lockup or disable the Mobile Station 110. A locked Mobile Station 110 can be unlocked by an unlock message from the Mobility Orchestration Server 120 that initiated the lockup.

If branch 508 is taken, the Mobility Orchestration Server 120 checks if the user is registering from a foreign cellular network indicated by the user IMSI and Location Area Id, the home Mobility Orchestration Server 120 then locates a Visited Mobility Orchestration Server 120 that is closest to the user and have the user register with the Visited Mobility Orchestration Server 120 as outlined in FIG. 6a. In this scenario, we assume the user is registering locally. The Mobility Orchestration Server 120, after registered the Personal Mobility Assistant 111, sends a signed 5081—Registration Granted message to the Personal Mobility Assistant 111. Upon receipt of 5081, Personal Mobility Assistant 111 starts step 5082 to authenticate the Mobility Orchestration Server 120. It decrypts message 5081 with the Home Mobility Orchestration Server's 120 public key received at the time the Personal Mobility Assistant 111 was first configured. If the decryption succeeds, the Home Mobility Orchestration Server 120 is authenticated. Upon successful authentication of the Mobility Orchestration Server 120, the Personal Mobility Assistant 111 executes step 5083 to completes the registration process and notify the user that the mobile is online. This concludes the signalling channel establishment method.

When an incoming call for the user is received at the voice switch 105 with a 509 Setup to User Business # from Calling CLID message, the voice switch 105 starts step 510 to handle the incoming call by applying the user's termination features, such as call screening, distinctive ringing, and Mobility Orchestration Server 120 support. Upon determination that the user has Mobility Orchestration Server 120 support, it sends 511—Setup to User Business# from calling CLID message to the Home Mobility Orchestration Server 120 supporting the user. In step 512, upon receipt of message 511, the Mobility Orchestration Server 120 retrieves the user profile associated with the user from Information Storage 241. It retrieves the current user location information. It retrieves the current user IMSI if the user is registered in a cellular network; it retrieves the capability information of the Mobile Station 110 and the incoming call handling preference. In step 513, it selects an appropriate bearer channel such as a cellular radio, a Virtual Private Network connection, or an Internet connection, to deliver the incoming call to the user. Upon selection of the channel, it maps the user's feature profile to the selected channel. In step 514, it setup a call using the bearer channel selected to delivering the incoming call to the user. It also updates the user's presence information either locally in the Mobility Orchestration Server 120 or externally in an Office Productivity Service server 106. In this scenario, the user has indeed registered in a GSM cellular network at the time the incoming call arrives. With the user's current registered IMSI, a GSM radio interface on the Mobility Orchestration Server 120 with a calling line id of VMN CLID is selected and it sends 515—info Invite to user IMSI from VMN CLID, calling CLID, cellular, information message to inform the Personal Mobility Assistant 111 that an incoming call from calling CLID is about to be delivered to the user via VMN CLID and the allocated bearer channel is cellular. Upon receipt of message 515, Personal Mobility Assistant 111, executes step 516 to prepare for incoming call from calling CLID from the cellular network. About the same time when Mobility Orchestration Server 120 sends message 515 to the Personal Mobility Assistant 111, it also sends the 517—Setup to user IMSI from VMN CLID message to the cellular network to deliver the actual call to the user. Upon receipt of message 517, the cellular network sends the call to the user via 518—Setup to user IMSI from VMN CLID message. Upon receipt of message 518, Personal Mobility Assistant 111, checks the incoming call against the pending call from step 516 and concluded it is the same call. It then modifies the incoming CLID from VMN CLID to calling CLID from step 516 and presents that to the user in step 519. When the user answers, Personal Mobility Assistant returns 520—Connect message to the cellular network. The connect message is relayed via 521, 522, and 523 messages to the calling switch and the call is connected end to end. At about the same time when the Personal Mobility Assistant 111 sends message 520, it also sends a 524—Info—connected to calling CLID message to inform the Mobility Orchestration Server 120. Upon receipt of message 524, the Mobility Orchestration Server 120 updates the user's presence information either locally in the Mobility Orchestration Server 120 or externally in an Office Productivity Service server 106. This concludes the method to establish a signalling channel between Mobility Orchestration Server 120 and Personal Mobility Assistant 111 and the method to allocate a bearer channel for incoming call using cellular network.

FIG. 5b outlines the method to handle an outgoing call from a Mobile Station 110 and how the Mobile Station 110, while connected to the cellular network, invokes features on an enterprise voice switch. The method starts with step 530 when the user initiates a call to called CLID. Prior to step 530, the system is in a steady state where the Mobile Station 110 is registered with the cellular network and has an active data channel with the cellular network. It also has registered with the Mobility Orchestration Server 120 and has an active signalling channel between the Personal Mobility Assistant 111 and the Mobility Orchestration Server 120. Upon receipt of action 530, Personal Mobility Assistant 111 executes step 531 to present user interface feedback to the user about the outgoing call the user is attempting to make. It then sends 532—info—Invite to Called CLID message to request the Mobility Orchestration Server 120 to place an outgoing call for the user to called CLID. Upon receipt of request 532, the Mobility Orchestration Server 120 executes steps 533 to 536 to service the request. In step 533, it allocates an access bearer channel to connect with the user based on information such as, the media channel requirement of call the user is making and the location the user is making from. In Step 534, it maps the user's feature profile to the selected bearer channel to enable all features the user has access to. In step 535, it originates a call to connect to the user using the selected bearer channel. Step 535 is broken into two steps. First it sends 5351—info—invite Ack (from VMN CLID, Cellular) message to inform the Personal Mobility Assistant 111 that the Mobility Orchestration Server 120 is servicing the outgoing call request and has assigned a cellular bearer channel for the user to connect to the call and that the Personal Mobility Assistant should expect the call coming from VMN CLID. Secondly, about the same time, it sends 5353—setup to user IMSI from VMN CLID message through the Cellular network to connect to the user. Upon receipt of message 5351 the Personal Mobility Assistant 111 execute step 5352 to prepare to connect to the Mobility Orchestration Server for the outgoing call and presents the appropriate user interface to the user. Upon receipt of message 5353, the cellular network sets up the call to the Mobile Station 110 with a 5354—Setup to User IMSI from VMN CLID message. Upon receipt of message 5354, the Personal Mobility Assistant 111, checks the incoming call against the pending connection to the Mobility Orchestration Server 120 for the outgoing call from step 5352 and concluded it is the expected call. It completes step 5352 and connects to the Mobility Orchestration Server 120 without alerting the user. A connect message is sent to the Visited Mobility Orchestration Server 120 by message 5356 and 5357 via the cellular network. Upon receipt of message 5357, the Mobility Orchestration Server 120 connects the cellular connection to the user with the call to the called CLID initiated by step 536. As part of step 536, the Mobility Orchestration Server 120 sends 5361—Setup to called CLID from user Business# message to the voice switch 105. Upon receipt of message 5361, Voice switch 105 initiates step 5362 to execute the user's call origination features, such as outgoing call restrictions. Voice switch-based call restrictions such as no 900 number calls and no international long distance calls can easily be extended to cellular mobile users with this scheme. As part of step 5362, the voice switch 105 sends a 5363—Setup to called CLID from user Business# message to the called party. Upon receipt of 5364—Alerting message, the voice switch 105 sends the Alert message to Mobility Orchestration Server 120 with 5363—Alerting message. Mobility Orchestration Server 120 then relay the far-end alerting message to the Personal Mobility Assistant 111 via an information messages 5366. At the time when Voice Switch 105 receives the 5363 Alert message, the user would hear 5367—Ringback tone from the far end switch. When the called CLID user answers the call, connect message 5368 is sent to the voice switch 105. Upon receipt of message 5368, voice switch 105 sends 5369—Connect message to the Mobility Orchestration Server 120. Upon receipt of the 5369—Connect message, the Mobility Orchestration Server 120 executes step 5370 to update the user's presence information either locally in the Mobility Orchestration Server 120 or externally in an Office Productivity Service server 106. About the same time, it sends an information message 5371 to inform the Personal Mobility Assistant that the far end user called CLID has answered the call. At this point the end-to-end voice media connection 538 is established. About the same time the voice switch 105 sends the connect message 5369 to the user via the Mobility Orchestration Server 120, it also sends a user interface update information message using the virtual terminal definition defined between the voice switch 105 and Mobility Orchestration Server 120, as outlined in FIG. 4, to drive the user interface on the Mobile Station 110. The user interface update message may contain some display elements and some softkey buttons information representing context sensitive features that the user can invoke at the present call state. The user interface update message is relayed to the Personal Mobility Assistant 111 by the Mobility Orchestration Server 120 with message 540 and displayed to the user by the Personal Mobility Assistant 111 with step 541.

In step 542 the user selected a softkey corresponding to the 3WC feature. The Personal Mobility Assistant 111 sends the user selected action to the Mobility Orchestration Server 120 with information message 543. The Mobility Orchestration Server 120 relays the message to voice switch 105 without interpreting the content in accordance to the Virtual Terminal definition defined between the voice switch 105 and Mobility Orchestration Server 120. Upon receipt of message 544 from the Mobility Orchestration Server 120, the voice switch interprets the user selected action and determines that the user has chosen to invoke 3WC feature. It proceed to step 545 to initiate the 3WC feature and updates the user interface of the Mobile Station 110 with message 546, 548, and 549 through the Mobility Orchestration Server 120 and Personal Mobility Assistant 111. With this method, the voice switch 105 drives the user interface on the Mobile Station 110 to interact directly with the user via the Mobility Orchestration Server 120 and Personal Mobility Assistant 111. This concludes the method to establishing outgoing call from Mobile Station 110 and to invoke features on a remote voice switch through a cellular network.

FIG. 6a outlines the method of registration when the user roamed to a foreign cellular network. The method starts with step 603 after the cellular data channel has been established between the Mobile Station 110 and the Cellular network 104. The cellular data channel can be a GSM GPRS channel connecting to the GSN node in the GSM network. Similar access and termination, well known to the skilled in the art, is used for other access networks such as a CDMA or WCDMA cellular network. To prepare for step 603 once the cellular data channel connected message 602 is received, Personal Mobility Assistant 111 retrieves the Personal Mobility Assistant's Identification address and the Home Mobility Orchestration Server's identification address, composes a Registration Request message, and signs it with the Private Key of the security certificate assigned to it by the Home Mobility Orchestration Server 120 at the time the Personal Mobility Assistant 111 was initialized and configured. In the preferred embodiment, both Mobility Orchestration Server and Personal Mobility Assistant identification addresses follows the structure of a Uniform Resource Identifier (URI). It also captures the Location Area Identifier (LAI) and the International Mobile Subscriber Identifier (IMSI) associated with the current cellular data connection. The message is addressed, through the GSM GSN node to the Home Mobility Orchestration Server 120. The Home Mobility Orchestration Server upon receipt of the Registration Request message 603, executes step 604 to authenticate the Personal Mobility Assistant 111. It first retrieves the Personal Mobility Assistant's identification address from the message, retrieves the associated public key from Information Storage 241, and decrypts the message. If the decryption succeeds, the Personal Mobility Assistant 111 is authenticated and access is granted. In step 605, it then updates the location register with the user's new location information. In step 606, it updates the Personal Virtual Mobile Network topology for the user based on the location information received. It adds the new location to the user's Personal Virtual Mobile Network, if the Location Area Identifier is not already part of the Personal Virtual Mobile Network. The Personal Virtual Mobile Network topology is also updated with location and radio signal strength information received from the user as the user roams. The broader Virtual Mobile Network topology is also updated if necessary. Then one of step 607, 608, and 609 is taken based on the lost-mobile flag associated with the Personal Mobility Assistant 111 and whether there is a Mobility Orchestration Server 120 is near the area the user is visiting. Branch 607 is taken if the Mobility Orchestration Server 120 found that the Personal Mobility Assistant 111 is marked as lost by the lost-mobile flag. Branch 608 is taken if the Mobility Orchestration Server 120 found that the Personal Mobility Assistant 111 is not marked as lost by the lost-mobile flag, the Location Area Id indicated the user is registering from a foreign cellular network, and there is a Mobility Orchestration Server 120 near the user. Branch 609 is taken if neither 607 and 608 are taken which means that the Personal mobility Assistant 111 is not marked as lost by the lost-mobile flag and the Location Area Id indicates that the user is registering locally.

If branch 607 is taken the home Mobility Orchestration Server 120 sends a signed 6071 Device Lockup message to the Personal Mobility Assistant 111 to initiate the lockup of the Mobile Station 110. Upon receipt of message 6071, in step 6072, the Personal Mobility Assistant 111 decrypts message 6071 with the Mobility Orchestration Server's 120 public key received at the time the Personal Mobility Assistant 111 was first configured. If the decryption succeeds, the Home Mobility Orchestration Server is authenticated. Upon successful authentication, it executes step 6073 to lockup or disable the Mobile Station 110. A locked Mobile Station 110 can be unlocked by an unlock message from the Mobility Orchestration Server 120 that initiated the lockup.

If branch 608 is taken the home Mobility Orchestration Server 120 it sends a signed 6081—Registration Redirect message to the Mobility Orchestration Server 120 near the user with the Personal Mobility Assistant's service profile with information such as feature access privileges, security keys required to communicate securely with the Personal Mobility Assistant. Upon receipt of message 6081, the Visited Mobility Orchestration Server 120 execute step 6082 to prepare to support the roaming user. Right after sending message 6081, the home Mobility Orchestration Server 120 also sends a signed 6083—Registration Redirect message to inform the Personal Mobility Assistant 111 to register with the selected Visited Mobility Orchestration Server 120 instead. Upon receipt of message 6083, the Personal Mobility Assistant 111 sends a signed 6084—Registration Request message to the Visited Mobility Orchestration Server 120 to register. In step 6085 the visited Mobility Orchestration Server 120 retrieves the Personal Mobility Assistant's identification address from the message, retrieves the associated public key from the user profile of the Personal Mobility Assistant sent by the home Mobility Orchestration Server 120, and decrypts the message. If the decryption succeeds, the Personal Mobility Assistant 111 is authenticated and access is granted. In step 6086, it assigns visitor resources such as a visited CLID on the visited voice switch 105 to facilitate call redirection from the user's home voice switch 105 to the visited voice switch 105 near the user. It allocates necessary resources in the visited location register and creates a Visited Personal Virtual Mobile Network for the Mobile Station 110 to facilitate tracking of the user's location while he is registered with the visited Mobility Orchestration Server 120 in step 6087. It then sends message 6088 to inform the home Mobility Orchestration Server 120 that the Personal Mobility Assistant 111 is registered. It also sends message 6089 to inform the Personal Mobility Assistant 111 that its registration request has been successfully executed. Upon receipt of message 6089, the Personal Mobility Assistant 111 authenticates the visited Mobility Orchestration Server 120 similar to the way it authenticates the home Mobility Orchestration Server 120 in step 6072 since the visited Mobility Orchestration Server 120 assumes the same security identity with the same security keys as the Personal Mobility Assistant's home Mobility Orchestration Server 120. It completes the registration process after authenticated the visited Mobility Orchestration Server successfully.

If branch 609 is taken the home Mobility Orchestration Server 120 register the Personal Mobility Assistant 111 and sends a signed 6091 message to inform the Personal Mobility Assistant that the registration is successfully executed. Upon receipt of message 6091 the Personal Mobility Assistant 111 authenticates the home Mobility Orchestration Server 120 similar to step 6072 and completes the registration process.

After one of branches 607, 608, and 609 is taken, the Home Mobility Orchestration Server 120 updates the user's presence information either locally in the Mobility Orchestration Server 120 or externally in an Office Productivity Service server 106. This concludes the method of Registration While Roaming in a Foreign Cellular Network.

FIG. 6b outlines the method of location-based incoming call routing when the user is registered remotely with a visited Mobility Orchestration Server 120 through a foreign Cellular Network 104. The method starts with step 620 when an incoming call arrives at the user's home voice switch 105 from calling CLID for user's Business#. Upon receipt of message 621, the Home Mobility Orchestration Server 120 checks the location register for user and determined that the user has registered from a foreign cellular network as outlined in FIG. 6a. The user is served by a visited Mobility Orchestration Server 120 and is reachable with a Visited CLID address. With that information, it signals home voice switch 105 to redirect the incoming call to the user at Visited CLID with message 623. Upon receipt of message 623, the home voice switch 105 execute step 624 to redirect the incoming call via the enterprise's Virtual Private Network sending message 625 to the visited voice switch 105. Upon receipt of message 625, the visited voice switch 105 notifies the visited Mobility Orchestration Server 120 with message 626—setup to visited CLID from calling CLID. Upon receipt of message 626, the visited Mobility Orchestration Server 120 recognizes that Visited CLID is one of the visiting users registered locally. It executes step 627 to check the location of the visiting user identified by Visited CLID. It also checks the visiting user's Mobile Station's capabilities and the user's incoming call handling preference from the user profile information received from the user's home Mobility Orchestration Server when the user registered. In step 628, it allocates an access bearer channel at VMN CLID, a cellular radio channel for current implementation embodiment. It also maps the user's feature profile to the allocated bearer channel to ensure that the user has access to all the features he normally has access to. In step 629, it setup a connection to the user at user IMSI received from the Personal Mobility Assistant 111 at the time the Personal Mobility Assistant 111 registers with the Visited Mobility Orchestration Server 120. As a result of step 629, three messages, 630, 632 and 633 are sent. A 630—Info—Invite to User IMSI from VMN CLID, calling CLID, cellular message is sent from Mobility Orchestration Server 120 to Personal Mobility Assistant 111 to inform the Personal Mobility Assistant 111 that an incoming call from Calling CLID is about to be delivered to the user via cellular number VMN CLID. Upon receipt of message 630, Personal Mobility Assistant 111, executes step 631 to prepare for the incoming call from Visited Mobility Orchestration Server's 120 cellular radio channel identified with address VMN CLID. About the same time when the Visited Mobility Orchestration Server 120 send message 630, it sends message 632 to inform the Home Mobility Orchestration Server 120 that an incoming call from Calling CLID is being delivered to user at address user IMSI. It also sends the actual setup message 633 from the cellular radio channel to cellular network 104 connecting to the user at address user IMSI. Upon receipt of message 633 the cellular network 104 sends the call to the user via message 634. Upon receipt of message 634, Personal Mobility Assistant 111, checks the incoming call against the pending call from step 631 and concluded it is the expected call. It then modifies the incoming CLID from VMN CLID to calling CLID from step 631 and presents that to the user in step 635. When the user answers, Personal Mobility Assistant returns a 636—Connect message to the cellular network. The connect message is relayed via 637, 638, 639 and 640 messages to the calling voice switch and the call is connected end to end between the calling CLID party and the roaming user. Upon receipt of message 637, the Visited Mobility Orchestration Server 120 executes step 641 to update the user's presence information either locally in the Visited Mobility Orchestration Server 120 or externally in an Office Productivity Service server 106. It also sends message 642 to inform the home Mobility Orchestration Sever 120 that the roaming user has connected with the calling CLID party. In step 643, upon receipt of message 642 the Home Mobility Orchestration Server 120 also updates the user's presence information either locally in the Home Mobility Orchestration Server 120 or externally in an Office Productivity Service server 106. This concludes the method of location-based incoming call routing when the user is registered with a visited Mobility Orchestration Server 120 through a foreign cellular network.

FIG. 6c outlines the method to handle a roaming user making outgoing calls when registered with a Visited Mobility Orchestration Server 120 through a foreign cellular network. The method starts with step 640 when the roaming user initiates a call to called CLID. Upon receipt of the call initiation, Personal Mobility Assistant 111 responded with the appropriate user interface display to indicate to the roaming user that the call initiation to called CLID is underway. It then sends the call request to the Visited Mobility Orchestration Server 120 with message 642. Upon receipt of message 642, the Visited Mobility Orchestration Server 120 allocates an access bearer channel for the outgoing call. In step 644, it maps the user's feature profile to the allocated access channel to ensure that the user has access to all the features he normally has access to. It then executes steps 645 to setup a connection to the user at user IMSI via the allocated bearer access channel. The address user IMSI was received from the Personal Mobility Assistant 111, when it registered with the Visited Mobility Orchestration Server 120. As a result of step 645, messages 647, 648, and 649 are sent from the Visited Mobility Orchestration Server 120. Message 647 is sent to inform the Personal Mobility Assistant 111 that Visited Mobility Orchestration Server 120 is serving the outgoing call with a cellular connection from address VMN CLID. Message 648 is sent to the cellular network 104 to setup a connection from Visited Mobility Orchestration Server 120 at VMN CLID to the roaming user at user IMSI. Message 649 is sent to inform the Home Mobility Orchestration Server 120 that the roaming user is making a call to called CLID. Upon receipt of message 647 the Personal Mobility Assistant 111 execute step 650 to prepare to connect to the Visited Mobility Orchestration Server 120 at VMN CLID for the outgoing call and presents the appropriate user interface to the user. As part of step 646, the Visited Mobility Orchestration Server 120 retrieved the user's normal business phone address, Business#, from the user profile received from the Home Mobility Orchestration Server 120 at the time the roaming user registered. It then sends a 651—Setup to called CLID from user Business# message to the visited voice switch 105 to initiate the call and ensures that the called party will receive the call as if the call came from the user's normal Business# address. Upon receipt of setup message 651, in step 652, the visited voice switch 105 executes the call origination features associated with Visited CLID to ensure that the appropriate call origination features and restrictions are executed for the roaming user. Upon receipt of message 648, the cellular network 104 sends the call to the roaming user with message 653. Upon receipt of message 653, in step 654, the Personal Mobility Assistant 111, checks the incoming call against the pending connection to the Visited Mobility Orchestration Server 120 for the outgoing call from step 640 and concluded it is the expected call. It completes step 650 and connects to the Visited Mobility Orchestration Server 120 without alerting the user. A connect message is sent to the Visited Mobility Orchestration Server 120 by message 655 and 656 via the cellular network. Upon receipt of message 656, the Visited Mobility Orchestration Server 120 connects the cellular connection to the user with the call to the called CLID initiated by message 651. After step 652, the visited voice switch sends message 657 to setup the call to the called party with calling party identifier as user Business# received from the visited Mobility Orchestration Server 120 with message 651. As the called party's voice switch return alert message, the message is relayed to the user via messages 659, 660 and 661. Ringback tone is also sent from the called party's voice switch to the roaming user via signal 662. When the called party at called CLID answers, a connect message is relayed to Personal Mobility Assistant 111 with messages 663, 664, and 665. Upon the called party at called CLID answers the call a 668 end to end bearer connection is established between the called party at called CLID and the roaming user at user IMSI. Upon receipt of message 664, the Visited Mobility Orchestration Server 120 sends a message 666 to inform the Home Mobility Orchestration Server 120 that the roaming user is connected with the called party at called CLID. Upon receipt of message 666, the Home Mobility Orchestration Server 120 updates the user's presence information either locally in the Home Mobility Orchestration Server 120 or externally in an Office Productivity Service server 106. This concludes the method to handle a user making outgoing calls when registered with a Visited Mobility Orchestration Server 120 through a foreign cellular network 104.

FIG. 6d outlines the method to handle outgoing calls from a roaming user registered through a foreign cellular network with the home Mobility Orchestration Server without any visited Mobility Orchestration Server support. The method starts with step 670 when the roaming user initiates a call to called CLID. Upon receipt of the call initiation, Personal Mobility Assistant 111 responded with the appropriate user interface display to indicate to the roaming user that the call initiation to called CLID is underway. It then sends the call request to the Home Mobility Orchestration Server 120 with message 672. Upon receipt of outgoing call request message 672, the Home Mobility Orchestration Server 120 executes one of branches 673 and 674.

Branch 673 is taken if the Location Area Identifier of the roaming user indicates that the user is registered from a foreign country and that the called CLID the user trying to call is also from the same foreign country. In step 673, the Home Mobility Orchestration Server 120 sends message 6731 to inform the Personal Mobility Assistant 111 that it is to originate the call locally. Upon receipt of message 6731, the Personal Mobility Assistant prepares to originate the call locally. It sends message 6733 to the visited cellular network 104 to setup the call to called CLID. When the called party at called CLID answers, Connect message 6734 is receipted from the visited cellular network 104. Upon receipt of message 6734, the Personal Mobility Assistant 111 sends message 6735 to inform the Home Mobility Orchestration Server 120 that it has successfully connected to the called CLID. Upon receipt of message 6735, the Home Mobility Orchestration Server 120 updates the user's presence information either locally in the Home Mobility Orchestration Server 120 or externally in an Office Productivity Service server 106. This concludes branch 673.

Branch 674 is taken if the Location Area Identifier of the roaming user indicates that the user is registered from a foreign country and that the called CLID the user trying to call is however from the roaming user's home country. In step 6741, the Home Mobility Orchestration Server 120 allocates an access bearer channel, which is an enterprise VPN connection at address VPN CLID, for the outgoing call. In step 6742, it maps the user's feature profile to the allocated access channel to ensure that the user has access to all the features he normally has access to. It then executes steps 6743 to setup a connection to the user at user IMSI via the allocated bearer access channel. The address user IMSI was received from the Personal Mobility Assistant 111, when it registered with the Home Mobility Orchestration Server 120. As part of step 6743, messages 6745, 6746, and 6760 are sent from the Home Mobility Orchestration Server 120. Message 6745 is sent to inform the Personal Mobility Assistant 111 that the outgoing call to called CLID id underway and the call is to be connected via cellular from CPN CLID. Message 6746 is sent to the home voice switch 105 to setup a connection to the roaming user at user IMSI using the enterprise Virtual Private Network from address VPN CLID. Message 6760 is sent to the home voice switch 105 to setup the connection to the called party at called CLID using the user's Business# as the origination address. Upon receipt of message 6745, in step 6748, the Personal Mobility Assistant 111 prepares for connection to the outgoing call from VPN CLID and makes the appropriate user interface updates to alert the user. Upon receipt of message 6746, in step 6749, the home voice switch 105 determines the least cost Virtual Private Network route to the roaming user at user IMSI and send the setup message 6750 to the visited cellular network 104. Upon receipt of message 6750, the visited cellular network sends the call to the roaming user with message 6751. Upon receipt of message 6751, in step 6752, the Personal Mobility Assistant 111, checks the incoming call against the pending connection to the Home Mobility Orchestration Server 120 for the outgoing call from step 670 and concluded it is the expected call. It completes step 6748 and connects to the Mobility Orchestration Server 120 without alerting the user. A connect message is sent to the Mobility Orchestration Server 120 by message 6753 and 6754 via the cellular network. Upon receipt of message 6754, the Mobility Orchestration Server 120 connects the cellular connection to the user with the call to the called CLID initiated by message 6760. Upon receipt of message 6760, the visited voice switch sends message 6761 to setup the call to the called party at called CLID with calling party identifier as user Business# received from the Home Mobility Orchestration Server 120 with message 6760. As the called party's voice switch return alert message, the message is relayed to the user via messages 6762, 6763 and 6764. Ringback tone is also sent from the called party's voice switch to the roaming user via signal 6765. When the called party at called CLID answers, a connect message is relayed to Personal Mobility Assistant 111 with messages 6766, 6767, and 6768. Upon the called party at called CLID answers the call a 6770 end to end bearer connection is established between the called party at called CLID and the roaming user at user IMSI. Upon receipt of message 6767, the Home Mobility Orchestration Server 120 updates the user's presence information either locally in the Home Mobility Orchestration Server 120 or externally in an Office Productivity Service server 106. This concludes the method to handle a user making outgoing calls when registered with a Home Mobility Orchestration Server 120 through a foreign cellular network 104 without support from any Visited Mobility Orchestration Server 120.

FIG. 7a outlines the method to handle a multimedia handover involving one of the bearer connections. The same method is extended to handover multiple connections when need. In this illustration, before the handover is needed, the user is active on a multimedia call with two bearer channels and a signalling channel with the Home Mobility Orchestration Server 120. Signalling channel 702 between Personal Mobility Assistant 111 and Home Mobility Orchestration Server 120 is connected via Cellular Data Channel connection 701b between the Personal Mobility Assistant 111 and Visited Cellular Network 104, using GPRS in the current embodiment, and Cellular Data Channel connection 701a between the Home Mobility Orchestration Server 120 and the visited Cellular Network 104, using secure internet HTTPS connection in the current embodiment. The video bearer channel 705 connecting to the Customer Relation Management server is constructed via three connections: 704, 703a, and 703b. Connection 704 between Home Mobility Orchestration Server 120 and the CRM server is a proprietary secure connection. Connection 703a between the Home Mobility Orchestration Server 120 and the WiFi radio network is an industry standard connection. The connection 703b between the WiFi radio Access Point and the Personal Mobility Assistant 111 is also an industry standard connection. The video channel 705 between the Home Mobility Orchestration Server 120 and the Personal Mobility Assistant 111, is secured with the security facilities outlined in the overall Virtual Mobile Network disclosed in a prior Provisional Patent Application US60/664,337 by the present inventor. The voice bearer channel between the Personal Mobility Assistant 111 and the Home Voice Switch 105 is constructed with three connections: 706, 707a and 707b. Connection 706 between the Home Mobility Orchestration Server 120 and the Home Voice Switch is a secure SIP/IP connection in the current embodiment. Connection 707a between the Home Mobility Orchestration Server 120 and the Visited Cellular Network 104 is a secure GSM voice connection. Connection 707b between the Mobile Station 110 and the Visisted Cellular Network 104 is also a secure GSM voice connection. The Personal Mobility Assistant 111 also has signalling connection to Visited WiFi Subnet 2 via connection 706.

This method starts with step 709 when the Multimedia Orchestration and Mobility Management functions in the Home Mobility Orchestration Server 120 determines in conjunction with the Personal Mobility Assistant 111, from a number of trigger factors such as Quality Of Service of the connections, load balance requirement of the system, and Path of Travel indication, that a handover of the video connection from WiFi Subnet 1 to WiFi Subnet 2, is required. In Step 710, the Home Mobility Orchestration Server 120 prepares and executes an inter-subnet handover of the video connection from WiFi Subnet 1 to WiFi Subnet 2. As part of step 710, the Home Mobility Orchestration Server 120 sends message 711 to inform the Personal Mobility Assistant 111, the connection with WiFi Subnet 1 is to handover to WiFi Subnet 2. Upon receipt of message 711, Personal Mobility Assistant 111 prepares for the handover. It sends message 713 to WiFi Subnet 2 to request access. As part of this step, but not shown, the Personal Mobility Assistant 111 establishes the necessary security credential, well know to the skilled in the art, with WiFi Subnet 2 to gain access. Upon receipt of access granted message 714 from the WiFi Subnet 2, Personal Mobility Assistant 111, sends message 715 to inform the Home Mobility Orchestration Server 120 that it is ready for the handover. Upon receipt of message 715, in step 716, the Home Mobility Orchestration Server 120 starts the handover preparation, starts the Handover Renewal timer. The Handover Renewal timer is set at the beginning of the handover process. The Handover Renewal timer is cancelled when the Personal Mobility Assistant 111 confirmed successful handover has taken place. If the timer expires before the handover occurs, the Mobility Orchestration Server 120 disconnects the Handover preparation connection and return to step 709. If the handover condition still holds, the Handover Renewal timer is set as part of step 710. This Handover Renewal timer ensures the connection that is ready for the Personal Mobility Assistant 111 is not redirected elsewhere, such as voice mail, by the access network before it is answered by the Personal Mobility Assistant 111. Once the timer is set, a handover connection is established through WiFi Subnet 2 to the Personal Mobility Assistant via message 717 and 718. Upon receipt of message 718, the Personal Mobility Assistant 111, recognizes that the handover connection is ready, it monitors the performance condition of both the handover connection from Subnet 2 and the existing connection to Subnet 1 and decides if it should complete the handover. If it decides to stay with Subnet 1, eventually the Handover Renewal timer set at the Home Mobility Orchestration Server 120 would expires and the connects from Subnet 2 would disconnect. If it decides that the Subnet 1 connection has deteriorated and Subnet 2 connection is better, it response with message 721 to connect to Subnet 2 and sends message 722 to the Home Mobility Orchestration Server 120 to confirm that the handover to Subnet 2 has completed successfully. Upon receipt of message 722, the Home Mobility Orchestration Server 120 executes step 723 to determine which of the connections via Subnet 1 or Subnet 2 is to be kept from a number of indicators such as Quality Of Service, radio signal strength and system load balancing requirements. In Step 724, the un-needed connection is released. In step 725, the Home Mobility Orchestration Server 120 updates the user's presence information either locally in the Home Mobility Orchestration Server 120 or externally in an Office Productivity Service server 106. At this point the video channel between the Personal Mobility Assistant 111 and the CRM server is constructed of connection 704 between the CRM server and the Home Mobility Orchestration Server 120; connection 708a, between the Home Mobility Orchestration Server 120 and the WiFi Subnet 2; and connection 708bn between the WiFi Subnet 2 and Personal Mobility Assistant 111. The Personal Mobility Assistant 111 maintains a signalling connection 703a with WiFi Subnet 1 to monitor the radio signal strength in case a handover back to Subnet 1 is needed. This concludes the method to handle a multimedia handover involving one of the bearer connections.

What is claim is:

1. A dynamic personal virtual mobile network, comprising:
a mobility orchestration server having a provider patch panel and a user patch panel;
a plurality of producers of multimedia service interconnected to the provider patch panel of the mobility orchestration server; and
a plurality of mobile stations interconnected to the user patch panel of the mobility orchestration server.
